(19) United States
(12) Patent Application Publication
(10) Pub. No.: US 2026/0052120 A1
(43) Pub. Date: Feb. 19, 2026

(54) COMMUNICATION PLATFORM

(71) Applicant: Dori Peleg, Kiryat Bialik (IL)

(72) Inventor: Dori Peleg, Kiryat Bialik (IL)

(21) Appl. No.: 19/299,739

(22) Filed: Aug. 14, 2025

Related U.S. Application Data
(60) Provisional application No. 63/682,938, filed on Aug. 14, 2024.

(51) Int. Cl. H04L 51/214; G06F 40/205; G06F 40/40; G06Q 10/1053; H04L 67/306

(52) U.S. Cl. CPC H04L 51/214; G06F 40/205; G06F 40/40; G06Q 10/1053; H04L 67/306

(57) ABSTRACT

In aspects, a processor-implemented method includes: storing information of users of a communication platform, where the information includes a digital resource and a warmth level for each of the users, where the users include a first user and a second user; permitting the first user to send an electronic message to the second user by expending an amount of the digital resource, where the amount of the digital resource to be expended is one of: constant regardless of the warmth level of the second user, or based on the warmth level of the second user; and permitting the second user to send an electronic message to the first user by expending an amount of the digital resource, where the amount of the digital resource to be expended is one of: constant regardless of the warmth level of the first user, or based on the warmth level of the first user.

### CROSS-REFERENCE TO RELATED APPLICATIONS

The present application claims priority to U.S. Provisional Application No. 63/682,938, filed Aug. 14, 2024, which is hereby incorporated by reference in its entirety.

### TECHNICAL FIELD

The present disclosure relates to a communication platform, and more particularly, to a communication platform for users to find each other and that may have various aspects that utilize machine learning models.

### BACKGROUND

Traditional approaches to computing required programmers to manually implement software modules to perform desired computations or tasks. This had been the paradigm for implementing computing platforms since the creation of computers. More recently, advancements in machine learning technology have provided an alternative approach to implementing certain aspects of computing platforms. For example, machine learning models may be trained using input and output data where the output data is known to be the result of the input data. During the training, machine learning models are able to configure their internal parameters to take the input data and to produce outputs that most closely approach or match the known output data. Such training occurs without requiring programmers to manually adjust the internal parameters of the machine learning models. The new paradigm of implementing certain aspects of computing platforms using machine learning models enables new computing platforms that were not possible under the traditional approach.

### SUMMARY

The present disclosure relates to a communication platform for users to find each other and that may implement machine learning models.

In accordance with aspects of the present disclosure, a processor-implemented method includes: storing information of a plurality of users of a communication platform, where the information includes a digital resource and a warmth level for each user of the plurality of users, where the plurality of users includes a first user and a second user; permitting the first user to send an electronic message to the second user by expending an amount of the digital resource of the first user, where the amount of the digital resource of the first user to be expended is one of: constant regardless of the warmth level of the second user, or based on the warmth level of the second user; and permitting the second user to send an electronic message to the first user by expending an amount of the digital resource of the second user, where the amount of the digital resource of the second user to be expended is one of: constant regardless of the warmth level of the first user, or based on the warmth level of the first user.

In various embodiments of the processor-implemented method, the amount of the digital resource of the first user to be expended is higher when the warmth level of the second user is warmer, and the amount of the digital resource of the first user to be expended is lower when the warmth level of the second user is lower.

In various embodiments of the processor-implemented method, the method further includes, for each user of the plurality of users: determining, for messages received by the respective user, a percentage of the messages to which the respective user has replied; and determining the warmth level of the respective user based on the percentage.

In various embodiments of the processor-implemented method, the method further includes determining an amount of new digital resource to be added to the digital resource of the first user, where the amount of the new digital resource to be added is based on the warmth level of the first user.

In various embodiments of the processor-implemented method, the method further includes adding, on a recurring basis, the amount of the new digital resource to the digital resource of the first user.

In various embodiments of the processor-implemented method, the amount of the new digital resource to be added to the digital resource of the first user is based further on a setting of the first user indicating a number of messages that the first user is willing to receive, in a period of time, from other users of the plurality of users.

In various embodiments of the processor-implemented method, the method further includes: determining that the number of messages that the first user is willing to receive, in a first period of time, from other users has been reached; based on the determination, holding further messages sent to the first user during the first period of time; and during a second period of time after the first period of time, delivering at least one of the further messages to the first user.

In various embodiments of the processor-implemented method, the plurality of users includes a third user who joined the communication platform based on an invitation from the first user, where the amount of the new digital resource to be added to the digital resource of the first user is based further on at least a portion of the digital resource of the third user.

In various embodiments of the processor-implemented method, the information of the plurality of users of the communication platform includes, for the first user, at least one work experience and at least one education of the first user. The processor-implemented method further includes: receiving a document containing text reflecting work experience and education of the first user, inputting the text to a trained machine learning model, and outputting, by the trained machine learning model, based on the text, the at least one work experience and the at least one education of the first user.

In various embodiments of the processor-implemented method, the information of the plurality of users of the communication platform includes, for the first user, at least one job skill of the first user and at least one years-of-experience corresponding to the at least one job skill. The processor-implemented method further includes: receiving a document containing text reflecting work experience of the first user, inputting the text to a trained machine learning model, and outputting, by the trained machine learning model, based on the text, the at least one job skill of the first user, the at least one years-of-experience corresponding to the at least one job experience, and a start date and an end date of the at least one job experience.

In various embodiments of the processor-implemented method, the trained machine learning model is a large language model (LLM). The method further includes inputting to the LLM a prompt detailing a way in which the text is to be parsed and detailing fields in which the text are to be stored, where the LLM provides a structured output.

In various embodiments of the processor-implemented method, the information of the plurality of users of the communication platform further includes, for the first user, at least one of: start and end times for a position, of the first user, associated with the at least one job skill, at least one completed education experience, at least one incomplete education experience, or at least two work experiences.

In various embodiments of the processor-implemented method, the method further includes: receiving a search request from the first user to search for other users of the plurality of users; conducting a search based on the search request to identify matched users of the plurality of users; and providing, to the first user, search results including certain information of the matched users.

In various embodiments of the processor-implemented method, the search request includes search parameters, where the search parameters include at least one of: average number of years at a company, time since changed companies, time since changed positions within a company, number of years in a job skill, an indication to not search past work experience and to search only current work experience, or an indication to search past work experience differently from searching current work experience.

In various embodiments of the processor-implemented method, based on the indication to search past work experience differently from searching current work experience, the search parameters further include at least one of: past job types, past job titles, past company status, past company sectors, past number of company employees, or past company name.

In various embodiments of the processor-implemented method, in the search results, the certain information of the matched users does not include identity of the matched users.

In various embodiments of the processor-implemented method, the method further includes, based on the first user connecting with at least one matched user of the matched users, providing the first user with access to identity of the at least one matched user.

In various embodiments of the processor-implemented method, for at least one matched user of the matched users, the information of the at least one matched user in the search results does not include a company name of the at least one matched user.

In various embodiments of the processor-implemented method, the conducting the search includes determining a distance value between the first user and another user of the plurality of users.

In various embodiments of the processor-implemented method, the determining the distance value between the first user and the another user includes: for each information element of a plurality of information elements of the first user and of the another user, computing a distance value for the respective information element; and computing the distance value between the first user and another user as a weighted sum of the distance values of the respective information elements.

In various embodiments of the processor-implemented method, the determining the distance value between the first user and another user includes executing a trained machine learning model.

In various embodiments of the processor-implemented method, the method further includes: generating training data for training a machine learning model to determine distance values between a pair of users, where the training data includes ground truth distance values, where the ground truth distance values are generated based on at least one of: behavior of users choosing to look into search results and to send messages to connect with the search results, behavior of users choosing to look into search results but not to send messages to connect with the search results, or behavior of users choosing to not look into search results.

In various embodiments of the processor-implemented method, the method further includes: gathering review activity over time including at least one of: amount of time that a search result among the search results was displayed on a display screen, whether the search result among the search results was ever displayed on a display screen, or cursor activity relating to the search result among the search results.

In various embodiments of the processor-implemented method, the method further includes determining, based on the review activity, at least one of: whether the search result should not be included as a matched user of a subsequent search, or whether the search result should be positioned farther down in a subsequent search.

In various embodiments of the processor-implemented method, the method further includes: determining, based on the review activity, suggested search parameters; and providing the suggested search parameters to the first user.

In various embodiments of the processor-implemented method, the determining the suggested search parameters includes: training a machine learning model in real time as the review activity is generated; and executing the trained machine learning model, while the review activity is gathered over time, to provide the suggested search parameters.

In various embodiments of the processor-implemented method, the providing the suggested search parameters to the first user includes providing the suggested search parameters to the first user at a time after the first user has completed the review activity.

In various embodiments of the processor-implemented method, the method further includes: analyzing the information of the first user to identify certain information that has a meaningful benefit or detriment to the first user; and presenting, to the first user, the certain information that has the meaningful benefit or detriment to the first user.

In various embodiments of the processor-implemented method, the certain information that has the meaningful benefit to the first user includes information that increases chances of a successful connection to other users, and the certain information that has the detriment to the first user includes information that decreases chances of a successful connection to other users.

In various embodiments of the processor-implemented method, the method further includes determining a negative persona reflective of the certain information that has the meaningful detriment to the first user, where the negative persona corresponds to one of: messages from the first user that were not opened by a recipient, messages from the first user that were not answered by the recipient, messages from the first user that did not result in a connection with the recipient, or messages from the first user that resulted in a connection with the recipient but did not result in further benefits to the first user after the connection.

In various embodiments of the processor-implemented method, the method further includes determining a positive persona reflective of the certain information that has the meaningful benefit to the first user, where the positive persona corresponds to one of: messages from the first user that were opened by a recipient, messages from the first user that were answered by the recipient, messages from the first user that resulted in a connection with the recipient, or messages from the first user that resulted in a connection with the recipient and resulted in further benefits to the first user after the connection.

In various embodiments of the processor-implemented method, the method further includes permitting the first user to create a persona based on at least one of the certain information that has a meaningful benefit or detriment to the first user.

In various embodiments of the processor-implemented method, the method further includes, in a case where the second user is registered using a private email address, permitting the second user to receive the electronic message but preventing the second user from sending any electronic messages.

In various embodiments of the processor-implemented method, one of the first user or the second user is a job seeker, and another one of the first user or the second user is a job hirer. The method further includes automatically matching the first user and the second user based on job parameters of the first user and job parameters of the second user, where the automatically matching is performed without the first user or the second user performing a manual search.

In various embodiments of the processor-implemented method, the first user is reporting a workplace harassment, the second user is a human resources personnel, and the electronic message indicates a context of reporting workplace harassment. The method further includes, based on the context of reporting workplace harassment, concealing an identity of the first user from the second user.

In various embodiments of the processor-implemented method, the method further includes: determining without human intervention, based on job titles of the plurality of users, when each of the plurality of users was a manager or an individual contributor; and providing analytics based on at least one of: when users were a manager or an individual contributor, number of cumulative years as a manager across all experiences, number of cumulative years as an individual contributor across all experiences, number of continuous years as a manager in latest experiences, number of continuous years as an individual contributor in latest experiences, number of cumulative years in a skill across all experiences, number of continuous years in a skill in latest experience, number of years (consecutive or cumulative) as a manager in latest X years of experiences, number of years (consecutive or cumulative) as an individual contributor in latest X years of experiences, number of years (consecutive or cumulative) in a skill in latest X years of experiences, percentage of time (consecutive or cumulative) as a manager across all years of experiences, percentage of time (consecutive or cumulative) as an individual contributor across all years of experience, percentage of time (consecutive or cumulative) as a manager in latest X years of experiences, percentage of time (consecutive or cumulative) as an individual contributor in latest X years of experiences, percentage of time (consecutive or cumulative) in a skill across all years of experiences, or percentage of time (consecutive or cumulative) in a skill in latest X years of experiences, where X>0 and X is configurable.

In various embodiments of the processor-implemented method, the method further includes: filtering the plurality of users based on at least one of: when users were a manager or an individual contributor, number of cumulative years as a manager across all experiences, number of cumulative years as an individual contributor across all experiences, number of continuous years as a manager in latest experience, number of continuous years as an individual contributor in latest experiences, number of cumulative years in a skill across all experiences, number of continuous years in a skill in latest experiences, number of years (consecutive or cumulative) as a manager in latest X years of experiences, number of years (consecutive or cumulative) as an individual contributor in latest X years of experiences, number of years (consecutive or cumulative) in a skill in latest X years of experiences, percentage of time (consecutive or cumulative) as a manager across all years of experiences, percentage of time (consecutive or cumulative) as an individual contributor across all years of experiences, percentage of time (consecutive or cumulative) as a manager in latest X years of experiences, percentage of time (consecutive or cumulative) as an individual contributor in latest X years of experiences, percentage of time (consecutive or cumulative) in a skill across all years of experiences, or percentage of time (consecutive or cumulative) in a skill in latest X years of experiences, where X>0 and X is configurable.

In accordance with aspects of the present disclosure, a system includes: one or more processors; and one or more memory storing instructions which, when executed by the one or more processors, causes the system to perform any combination of methods of the preceding paragraphs.

In accordance with aspects of the present disclosure, a non-transitory processor-readable medium stores instructions which, when executed by one or more processors of a system, cause the system at least to perform any combination of methods of the preceding paragraphs.

The details of one or more embodiments of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A detailed description of embodiments of the disclosure will be made with reference to the accompanying drawings, wherein like numerals designate corresponding parts in the figures:

FIG. 1 is a diagram of an example of an online environment that includes user devices communicating with a communication platform system over a network, in accordance with aspects of the present disclosure;

FIG. 2 is a diagram of an example of a display screen for entering user information, in accordance with aspects of the present disclosure;

FIG. 3 is a diagram of an example of another display screen for entering user information, in accordance with aspects of the present disclosure;

FIG. 4 is a diagram of an example of a display screen for interacting with received messages, in accordance with aspects of the present disclosure;

FIG. 5 is a diagram of an example of a display screen for interacting with sent messages, in accordance with aspects of the present disclosure;

FIG. 6 is a diagram of an example of a display screen for setting degrees to which a user would like to utilize the communication platform, in accordance with aspects of the present disclosure;

FIG. 7 is a diagram of an example of a displaying screen showing user engagement with the communication platform by inviting other users to join the communication platform, in accordance with aspects of the present disclosure;

FIG. 8 is a diagram of an example of a display screen showing levels of user engagement with other users of the communication platform by replying to messages and showing credit value needed to message users according to their level of engagement, where higher credit values are needed to message users having higher levels of engagement, in accordance with aspects of the present disclosure;

FIG. 9 is a diagram of an example of a display screen showing a search screen for manually searching and finding other users of the communication platform, in accordance with aspects of the present disclosure;

FIG. 10 is a diagram of an example of a display screen showing search options that may be selected to search and find other users, in accordance with aspects of the present disclosure;

FIG. 11 is a diagram of an example of another display screen showing search options that may be selected to search and find other users, in accordance with aspects of the present disclosure;

FIG. 12 is a diagram of an example of a display screen showing a window for sending a message to a user that was found in the search screen, in accordance with aspects of the present disclosure;

FIG. 13 is a diagram of an example of a display screen showing analytics indicating progress in communicating and connecting with other users of the communication platform, in accordance with aspects of the present disclosure;

FIG. 14 is a diagram of an example of a display screen showing further analytics relating to individual characteristics of other users, in accordance with aspects of the present disclosure;

FIG. 15 is a diagram of an example of a display screen showing further analytics relating to company information of other users, in accordance with aspects of the present disclosure;

FIG. 16 is a diagram of an example of a display screen showing further analytics relating to message characteristics of messages communicated to other users, in accordance with aspects of the present disclosure;

FIG. 17 is a diagram of an example of a display screen showing further analytics relating to personas of other users who engaged with or did not engage with a user, in accordance with aspects of the present disclosure;

FIG. 18 is a diagram of an example of characteristics that form a persona or that may be selected to form a persona, in accordance with aspects of the present disclosure;

FIG. 19 is a diagram of an example of a display screen showing a messaging automation tool for automatically sending messages to other users, in accordance with aspects of the present disclosure;

FIG. 20 is a diagram of an example of a display screen showing parameters that a job seeker may configure to specify desired characteristics for a job, in accordance with aspects of the present disclosure;

FIG. 21 is a flow diagram of an example of an operation, in accordance with aspects of the present disclosure;

FIG. 22 is a block diagram of an example of components of a system, in accordance with aspects of the present disclosure;

FIGS. 23A and 23B is a diagram of an example of a display screen showing information relating to time in education, time as individual contributor, and time as manager, in accordance with aspects of the present disclosure; and

FIG. 24 is a diagram of an example of a display screen showing skills breakdown, in accordance with aspects of the present disclosure.

### DETAILED DESCRIPTION

The present disclosure relates to a communication platform that implements machine learning models. In aspects of the present disclosure, the machine learning models are implemented in a communication platform that enables users to find and communicate with other users.

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

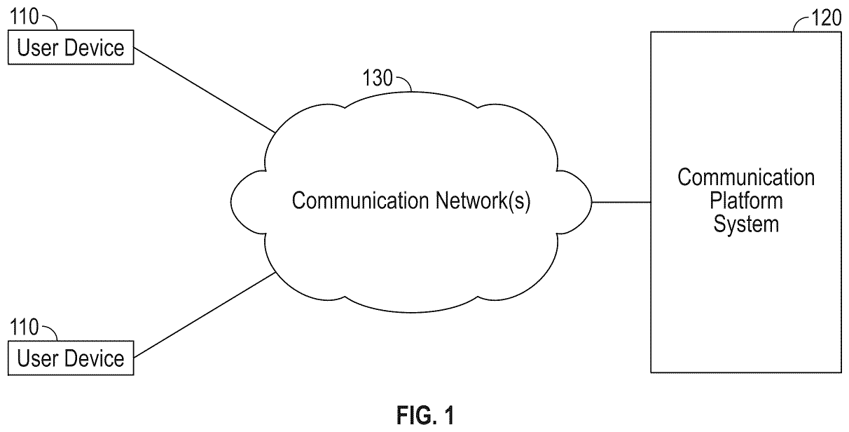

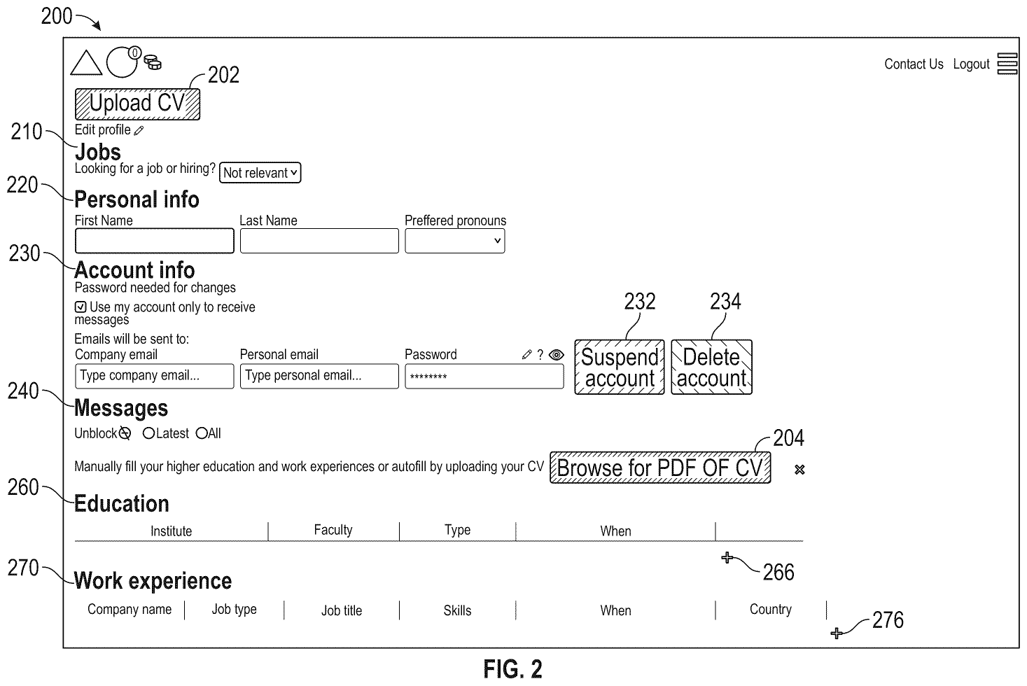

Referring to FIG. 1, there is shown a diagram depicting an online environment that includes user devices 110 communicating with a communication platform system 120 over one or more communication network(s) 130. The user devices 110 include a software app (not shown), which may be a dedicated app, a native app, or a web browser, that can communicating with the communication platform system 120. In various embodiments, the user device 110 can be a smartphone, a tablet, a laptop, a desktop computer, or another type of user device. As persons skilled in the art will understand, a user device 110 includes many components. Such components are not illustrated in FIG. 1 to provide a clearer illustration. Such other components can include, for example, a processor, memory, a display screen, an electronic storage, a networking transceiver (e.g., Wi-Fi, Ethernet), a user interface, a power source, an operating system (e.g., iOS, Android, Windows), a GPS (Global Positioning System) receiver, and/or other components which persons skilled in the art will recognize. The display screens of the software app will be described in more detail in connection with FIGS. 2-17. For now, it is sufficient to note that the software app enables display screens which allow users to find and communicate with other users.

The communication platform system 120 may be or include a cloud system, a standalone system, and/or a combination of a cloud system and a standalone system, among other possibilities. As persons skilled in the art will understand, a communication platform system 120 includes many components, and such components are not all illustrated in FIG. 1 to provide a clearer illustration. Such other components can include, for example, one or more processors, memory, electronic storage, a networking transceiver(s) (e.g., Wi-Fi, Ethernet), a user interface, a power source, an operating system (e.g., iOS, Windows), and/or other components which persons skilled in the art will recognize. The communication platform system also includes software and data that provide the display screens of FIGS. 2-17, which will be described in more detail below herein.

The communication network(s) 130 convey information between the user devices 110 and the communication platform system 120. The network(s) 130 represent a communication path between the user devices 110 and the communication platform system 120 and can span one or more types of networks, including, for example, a cellular network, a data communications network (e.g., Internet backbone), and a PSTN (public switched telephone network), among others. Persons skilled in the art will understand such portions of the communications path, and they are not illustrated separately or in detail in FIG. 1. As an example, the user device 110 may be a smartphone that is connected to a cellular network. The cellular network is then physically connected to the Internet backbone. The communication platform system 120 may be connected to the Internet backbone through data connections such as optical fiber, through telecommunication connections such as Ethernet cables, and/or through satellite connections such as VSAT ground stations, among other things. All such network components, protocols, and connections are contemplated to be within the scope of the network(s) 130.

The illustration of FIG. 1 is merely an example, and variations are contemplated to be within the scope of the present disclosure. For example, the communication platform system 120 may be implemented by more than one machine and may be geographically distributed. Such variations are contemplated to be within the scope of the present disclosure.

The following will describe examples of display screens shown in FIGS. 2-20. As described above, the display screens are displayed on a user device (e.g., 110, FIG. 1). In embodiments where the software app of the user device is a dedicated app or native app, all or portions of the display screens may be installed on the user device and may be populated with data provided by the communication platform (e.g., 120, FIG. 1.). In embodiments where the software app of the user device is an Internet browser, all or portions of the display screens may be provided by the communication platform and may be populated with data provided by the communication platform.

The display screens in FIGS. 2-20 illustrate a communication platform that allows users to find and communicate with other users based on educational and occupational information about users. FIGS. 2-20 are merely examples. Communication platforms that utilize other information about users are contemplated to be within the scope of the present disclosure.

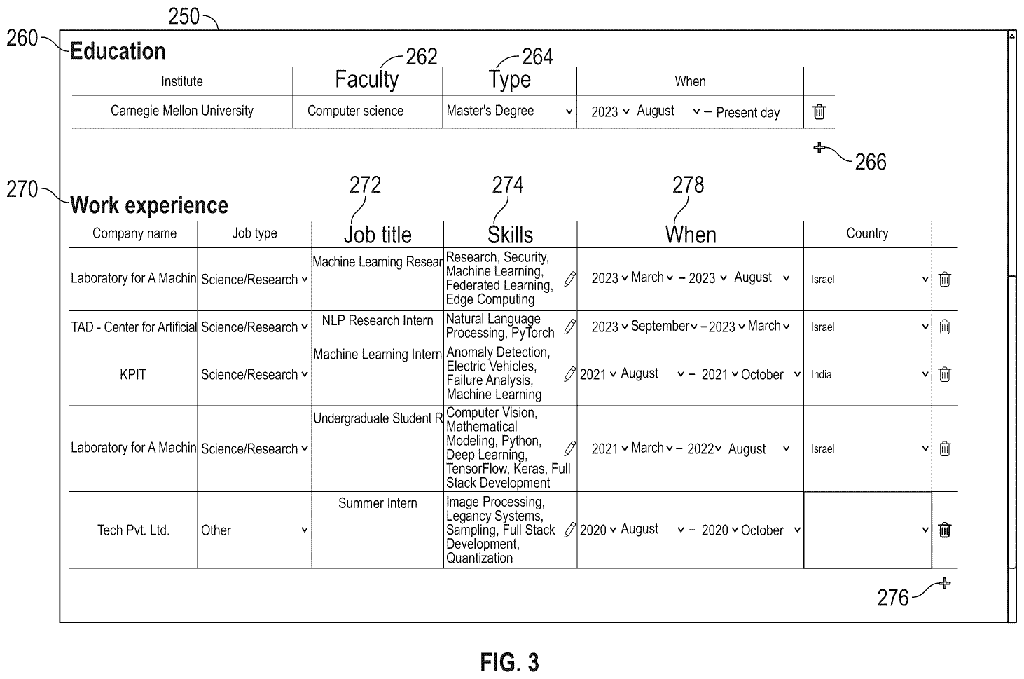

Referring now to FIG. 2 and FIG. 3, there is shown diagrams of an example of display screens 200, 250 for entering user information, such as jobs settings, personal information, account information, messages settings, education information, and work experience information. A user may scroll their display screen to scroll between the display screens 200, 250 of FIG. 2 and of FIG. 3. Some or all of the settings and/or information may be stored in a communication platform system (e.g., 120, FIG. 1), and some of the setting and/or information may be stored in a user device (e.g. 110, FIG. 1).

The jobs setting 210 may include choices indicating whether the user is looking for a job or hiring. The personal information 220 may include first name, last name, and preferred pronouns. The account information 230 may include company email address, personal email address, account password, a user interface element 232 to suspend account, and a user interface element 234 to delete account. The message settings 240 may include options to display only unblocked messages, only latest messages, or all messages. The education information 260 may include institution name, faculty name, type of degree, and dates of attendance. The work experience 270 information may include company name, job type, job title, skills, dates working in the position, and country of the job location.

In various embodiments, the faculty name 262 and type of degree 264 may be selected from various selections. Examples of faculty names and degrees are shown in the Example of Prompt shown below herein. The faculty names and degrees in the example are merely illustrative, and other faculty names and degrees are contemplated to be within the scope present disclosure.

In various embodiments, job type 272 may be selected from various selections. Examples of job types are shown in the Example of Prompt shown below herein. The job types in the example are merely illustrative, and other job types are contemplated to be within the scope present disclosure.

In various embodiments, job titles 272 and skills 274 may include any job title and any skill, which users may select from among selections or which users may manually input. In various embodiments, job skills 274 may be or include skills available in various social media platforms.

In various embodiments, the communication platform may require a person to have current work experience and a current company email address, in order to sign up for and join the communication platform. A benefit of requiring a current company email address is to discourage fake users from joining the platform. Having this requirement would require fake users to incur costs to open and use an email with a work-like domain name, which fake users generally would not be inclined do. Furthermore, requiring a current company email address focuses the usage of the communication platform on business purposes, as users generally avoid using their company email address in connection with non-work purposes. If a user subsequently becomes non-working after joining the communication platform, they may stay enrolled in the communication platform.

In various embodiments, the communication platform may allow users to use a private non-work email address, either as part of enrolling in the communication platform or by switching to a private email address after already being enrolled in the communication system. In such embodiments, users using a private non-work email address will not be able to send messages to other users. However, such users will be able to receive messages, such as messages about job offers, in case the user is unemployed.

The display screens 200, 250 of FIG. 2 and FIG. 3 include user interface elements (e.g., 266, 276) that allow a user to manually enter their settings and information. In accordance with aspects of the present disclosure, a machine learning model may be implemented for processing a resume or curriculum vitae (CV) document, extracting information from the document, and automatically populating the information fields in the display screen. The machine learning model may be invoked by uploading a CV via a user interface element (e.g., 202, 204). The machine learning model may be implemented by a large language model (LLM), such as GPT 3.5, which has a prompt detailing the way in which the text of the resume or CV should be parsed and detailing the fields in which the text should be stored, and which outputs structured output (e.g., Json format). The prompt may include examples of input CV text and examples of corresponding output. An example of a prompt is shown below. The example is merely illustrative, and any prompt which details the way in which the text of the resume or CV should be parsed and details the fields in which the text should be stored, is contemplated to be within the scope of the present disclosure. The benefit of implementing a machine learning model to process and extract information from a resume or CV is that it reduces burden for the user and thereby encourages the user to add this valuable information to the communication platform so that it is available for user searching purposes.

### Example of Prompt to LLM

You will read the following text of the CV marked at the end of this prompt and return a structured response in json format of the work experience and education based on the CV. The work experience will have the following fields: job_title, job_type, job_management_level, start_date_year, start_date_month, end_date_year, end_date_month, company_name, company_status, company_sector, company_size, company_website, location_country, location_city, job_responsibilities, job_skills.

The job_responsibilities is the responsibilities of the job which is the description provided for the job.

The job_skills will be the skills based on the job title and responsibilities of the specific work experience and also based on overall skill which are mentioned in the CV text. The skills must be standard LinkedIn skills. The skills should be provided per work experience and not overall skills. If the CV details the candidates skills, add to each work experience the skills that fit it according to the job title and the responsibilities. Don't just place them in one of the work experiences.

The start_date_year and end_date_year represent the start and end of the work experience. Their format should be a text of 4 digits. For example “2024” and not ‘24 or 2024.

The start_date_month and end_date_month should be a text of a number between 1 and 12 which represents the number of the month. For example, March should be set to “3”.

The field job_type should be the type of job based on the available information. It should be one of the following values:
Accounting/Finance
Animal Services
Arts/Entertainment/Gaming
Building/Construction
Business Intelligence
Business Management
C level/founder/owner
Consulting
Customer Service
Data Management/Administration
Engineering
Fashion/Beauty
Fitness/Wellness
Government/Social Work
Hardware
Healthcare
Hotel/Restaurant/Tourism
Human Resources
IT/Network Administration
Insurance
Law Enforcement/Security/Defense
Legal
Manufacturing/Warehouse/Production
Marketing/Advertising
Media/Communications
Non Profit
Management
Office/Administrative
Personal/Home Services
Project/Product/Program Management
Quality Assurance
Real Estate
Retail
Sales/Business Development
Science/Research
Skilled Trades/Manual Labor
Sport
Software Development/Architecture
Supply Chain/Logistics
Teaching/Training/Education/Students
Therapy
Transportation
Other

The field job_management_level should be the level of management of the job based on the job title. It should be one of the following values:
Chief Executive Officer or Owner
C level not including CEO or owner
Vice President
Director
Manager or Supervisor or Team Leader
Individual Contributor

The field company_size should be the estimated number of employees of the company based on the available information. If no such information is available, return NA.

The field company_status should get the value ‘Fortune 500’ if it is a Fortune 500 company based on the available information. If it is a Fortune 1000 company but not a Fortune 500 company, it should get the value ‘Fortune 1000’. Otherwise, it should get the value ‘Not Fortune 1000’.

The field company_sector should be the sector of the company based on the available information. It should be one of the following values:
Aerospace & Defense
Apparel
Business Services
Chemicals
Education
Energy
Engineering & Construction
Environmental
Financials
Food & Drug Stores
Health Care
Hotels, Restaurants & Leisure
Household Products
Industrials
Law
Materials
Media
Non profit
Motor Vehicles & Parts
Real Estate
Retailing
Technology
Telecommunications
Transportation
Wholesalers

If no such information is available, return NA.

The field company_website should be the link to the website of the company based on the available information. If no such information is available, return NA.

The education will have the following fields: university, degree, faculty, location_country, location_city, start_date_year, start_date_month, end_date_year, end_date_month, university_website.

The degrees will be one of the items in the following list:
Associate's Degree
Bachelor's Degree
Master's Degree
Doctoral Degree
Professional Degrees
Certificate Programs
Diploma Programs
Postgraduate Diplomas
Honorary Degrees

Under no circumstance can the answer be anything other than the items in the aforementioned list.

The faculties will be one of the items in the following list:
Anthropology
Archaeology
History
Linguistics and languages
Philosophy
Religion
Culinary arts
Literature
Performing arts
Visual arts
Economics
Geography
Interdisciplinary studies
Area studies
Ethnic and cultural studies
Organizational studies
Political science
Psychology
Sociology
Biology
Chemistry
Earth sciences
Physics
Space science
Computer science
Logic
The arts
Mathematics
Pure mathematics
Applied mathematics
Statistics
Systems science
Agriculture
Architecture and design
Business
Divinity
Education
Engineering and technology
Chemical engineering
Civil engineering
Electrical engineering
Materials science and engineering
Mechanical engineering
Industrial engineering
Environmental studies and forestry
Family and consumer science
Human physical performance and recreation
Journalism, media studies and communication
Law
Library and museum studies
Medicine and health
Military science
Public administration
Public policy
Social work
Transportation
Information Technology

Under no circumstance can the answer be anything other than the items in the aforementioned list. If the faculty name includes the word computer or computers, set it as Computer science. If there is no good fit to one of these faculty name, return the word Other.

The field university_website should be the link to the website of the university based on the available information. If no such information is available, return NA.

If any field in work experience or education is unavailable, return NA.

The text of the CV is:

Certain information such as skill(s) 274 for each work experience may be inferred by the LLM based on various parameters, such as the job title, the description of the responsibilities of the job, or overall skills mentioned in the CV. Requesting users to specify what skills they had in each work experience is tedious. Using the LLM to infer job skills 274, the user typically does not need to make any changes to the inferred job skills, and any changes that may be needed are generally only minor or partial changes.

In various embodiments, certain information such as when a user was a manager or an individual contributor (not shown) may be inferred by the LLM based on various parameters, such as the job title and/or the description of the responsibilities of the job, among other information. By inferring a user's roles as manager or individual contributor for each work experience, the communication platform can provide analytics and/or filters based on roles of users as a manager or an individual contributor.

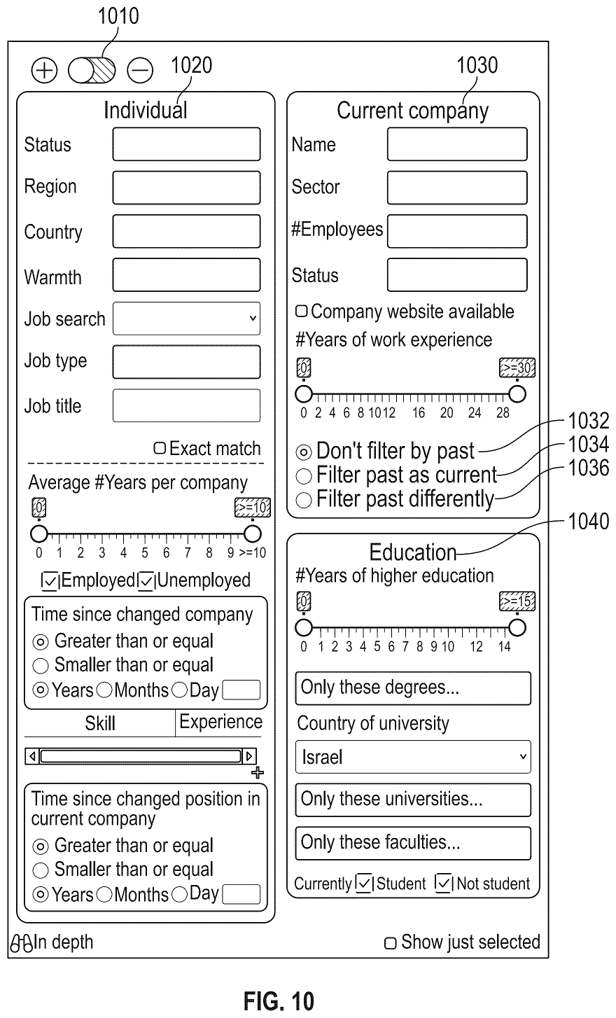

By inferring a user's skills 274 for each work experience and extracting the start and end times 278 of each work experience, the communication platform can determine the number of years a user has in each skill. As discussed in connection with FIG. 10, this information allows for searching and finding other users based on number of years of experience with a certain skill, rather than just whether or not other users have such a skill.

In various embodiments where the LLM is configured to receive only text as input, the communication platform performs a preprocessing step which includes optical character recognition (OCR) to transform the CV document into text. In various embodiments, a multimodal approach is used where the input to the machine learning model is an image (e.g., the CV document is an image file) and a prompt, and the machine learning model's output is the requested structured output.

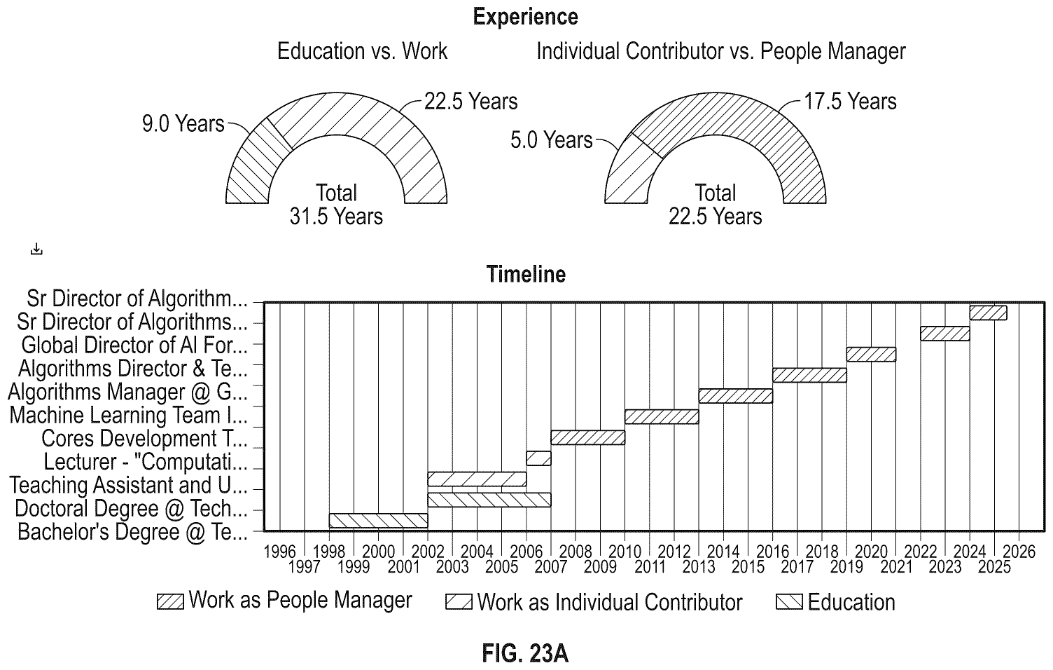

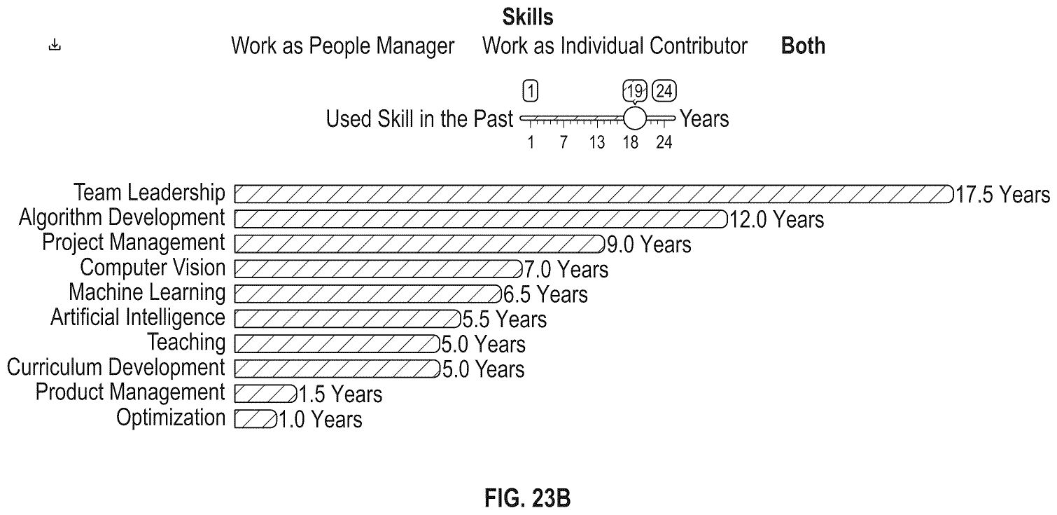

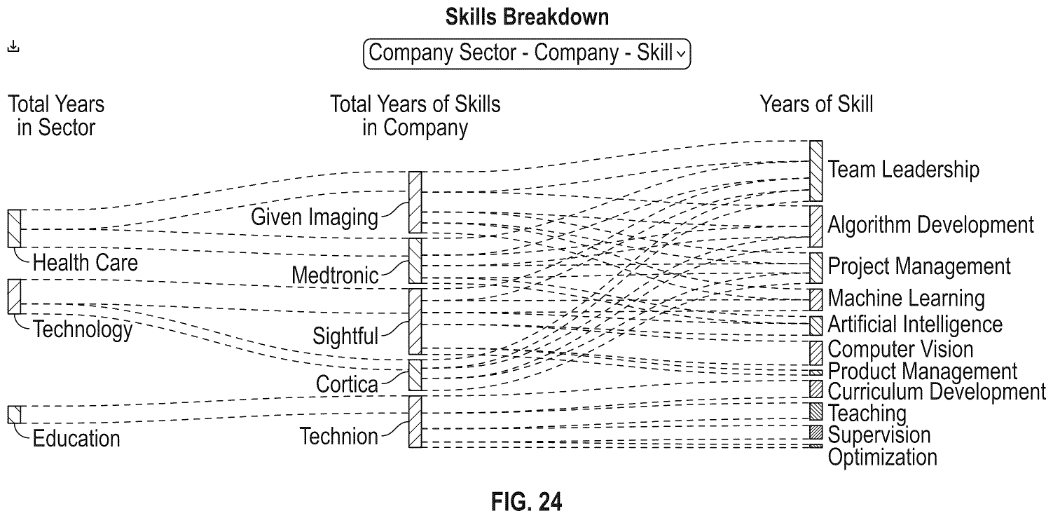

In various embodiments, a resume or CV of a user may be accessed and viewed. An icon (not shown), such as an “i” information icon (not shown), may be embedded in the displayed resume or CV to link to graphs and analytics of the person's resume, such as graphs and analytics shown in FIGS. 23A, 23B, and 24. FIGS. 23A and 23B are a diagram of an example of a display screen showing information relating to a user's time in education, time as individual contributor, and time as manager. In various embodiments, the display screen may show an experience display of charts of the user's amount of time in education and amount of time in work, or of the user's amount of time as individual contributor and amount of time as manager. In various embodiments, the display screen may show a timeline display of the user's experience over time and whether such experience was in education, as an individual contributor, or as a manager. FIG. 24 is a diagram of an example of a display screen showing skills breakdown, in accordance with aspects of the present disclosure. The display of FIG. 24 maps years in a sector to time at companies and maps years of skill to time at companies. The information in FIGS. 23A and 23B and FIG. 24 are merely examples, and other information different from those shown in FIGS. 23A and 23B and FIG. 24 are contemplated to be within the scope of the present disclosure. For example, the analytics may include one or more of: years of experiences as a manager, years of experiences as an individual contributor, number of cumulative years as a manager across all experiences, number of cumulative years as an individual contributor across all experiences, number of continuous years as a manager in latest experiences (e.g., in latest roles and/or jobs through current role/job), number of continuous years as an individual contributor in latest experiences (e.g., in latest roles and/or jobs through current role/job), number of cumulative years in a skill across all experiences, number of continuous years in a skill in latest experiences (e.g., in latest roles and/or jobs through current role/job), number of years (consecutive or cumulative) as a manager in latest X years of experiences, number of years (consecutive or cumulative) as an individual contributor in latest X years of experiences, number of years (consecutive or cumulative) in a skill in latest X years of experiences, percentage of time (consecutive or cumulative) as a manager across all years of experiences, percentage of time (consecutive or cumulative) as an individual contributor across all years of experiences, percentage of time (consecutive or cumulative) as a manager in latest X years of experiences (e.g., at least 60% of time as manager in latest 5 years of experiences), percentage of time (consecutive or cumulative) as an individual contributor in latest X years of experiences (e.g., at least 60% of time as manager in latest 5 years of experiences), percentage of time (consecutive or cumulative) in a skill across all years of experiences, or percentage of time (consecutive or cumulative) in a skill in latest X years of experiences, where X>0 and the value of X is configurable.

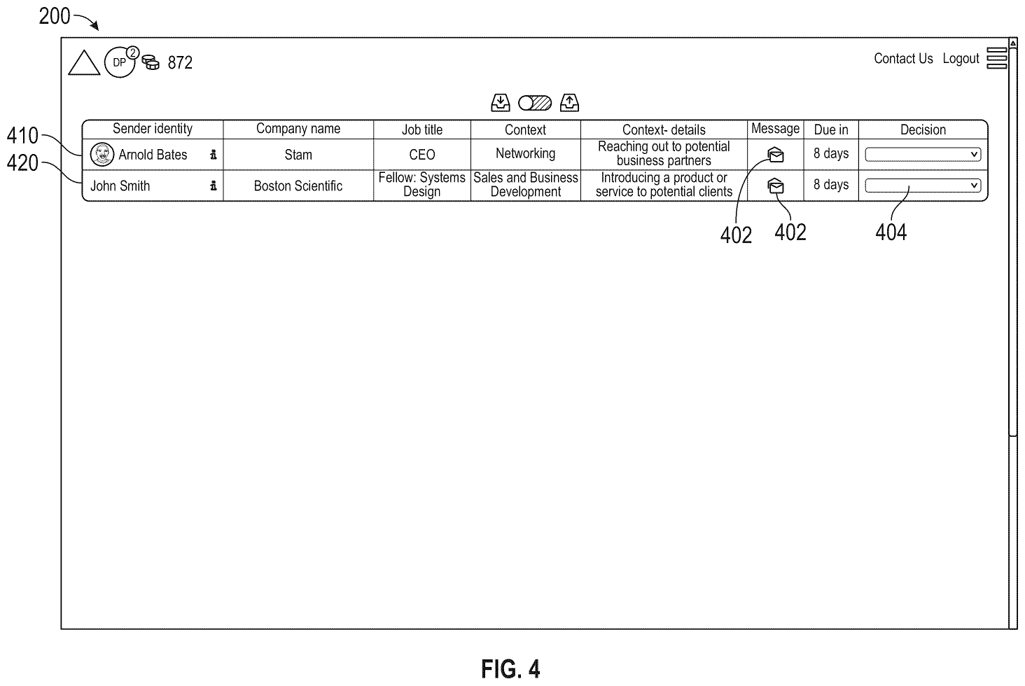

The display screens 200, 250 of FIG. 2 and FIG. 3 are merely examples, and variations are contemplated to be within the scope of the present disclosure. For example, other settings and information relating to jobs settings, personal information, account information, messages settings, education information, work experience information, and/or other user information, are contemplated to be within the scope of the present disclosure. For example, settings and/or information described below in connection with any of FIGS. 4-20 may be available in the display screen of FIG. 2 and/or FIG. 3. Additionally, such settings and information may be arranged differently than as shown in FIG. 2 and/or FIG. 3. In various embodiments, the display screens may not include all of the information shown in FIG. 2 and FIG. 3. Such and other variations are contemplated to be within the scope of the present disclosure.

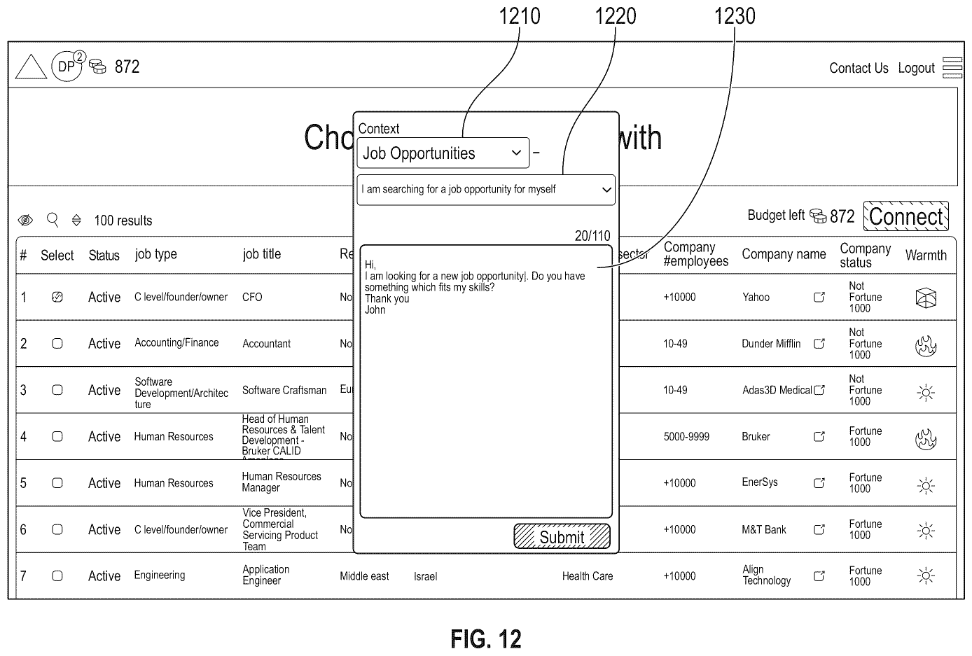

FIG. 4 is a diagram of an example of a display screen for interacting with a user's received messages. The example of FIG. 4 contains two received messages 410, 420. The received messages 410, 420 may include information such as sender identity, sender's company name, sender's job title, context of the message, context details of the message, an icon 402 for accessing contents of the message, due date for responding to the message, and the user's decision for connecting with the sender. Context and context details of the message will be described in connection with FIG. 12. For now, it is sufficient to note that the context and context details provide information about a sender's reason for sending a message. The user may engage the message icon 402 to view the text of a received message. After a user engages the message icon 402, the communication system can register the received message as having been opened by the user. In the illustrated embodiment, the user's decision for connecting with the sender is specified by a pulldown interface 404 that allows a user to select a decision about whether to connect with the sender. The pulldown interface 404 may include selections such as Yes, Remind me in 1 month, Remind me in 3 months, No, No and Block sender, and/or No and block sender and report offensive content, among other possibilities. If a user selects to be reminded in 1 month or 3 months, the communication platform can automatically set the reminder for the date in 1 month or in 3 months. If a user selects to block the sender from sending them a new message, the setting can be implemented by the communication platform. If the user selects to block and report the sender regarding offensive content in the message, the communication platform may limit the ability of the sender to send new messages to other users or may suspend or expel the sender from the communication platform entirely. The pulldown interface 404 and the selections are merely examples, and other user interfaces and selections are contemplated to be within the scope of the present disclosure.

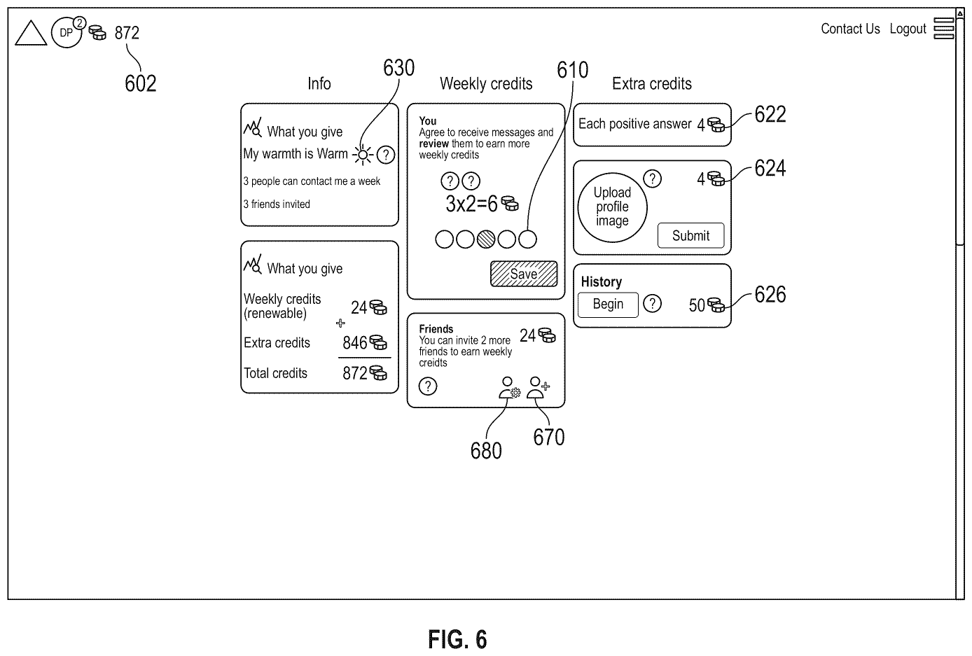

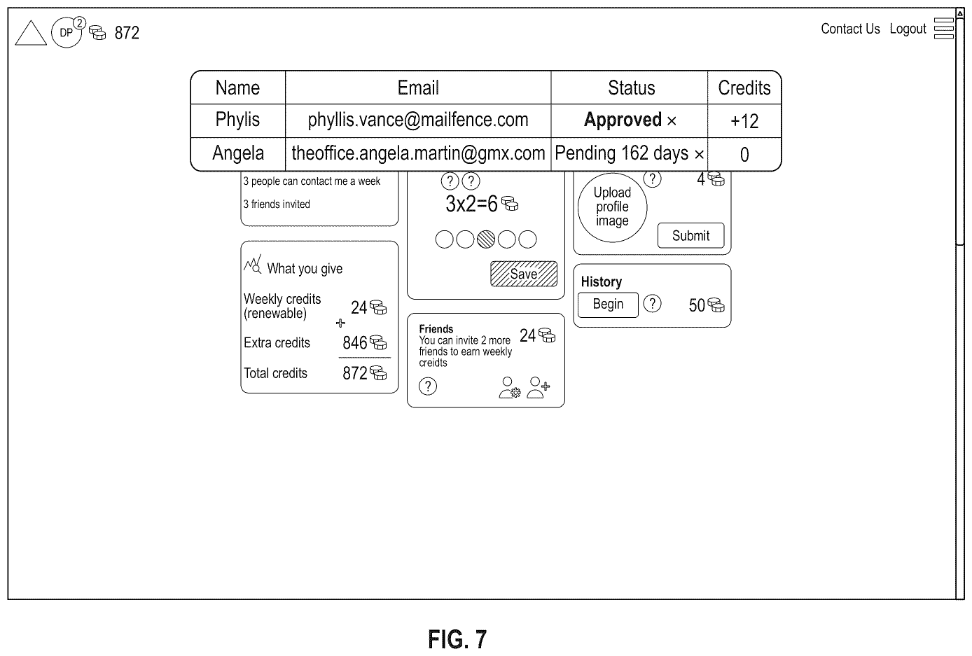

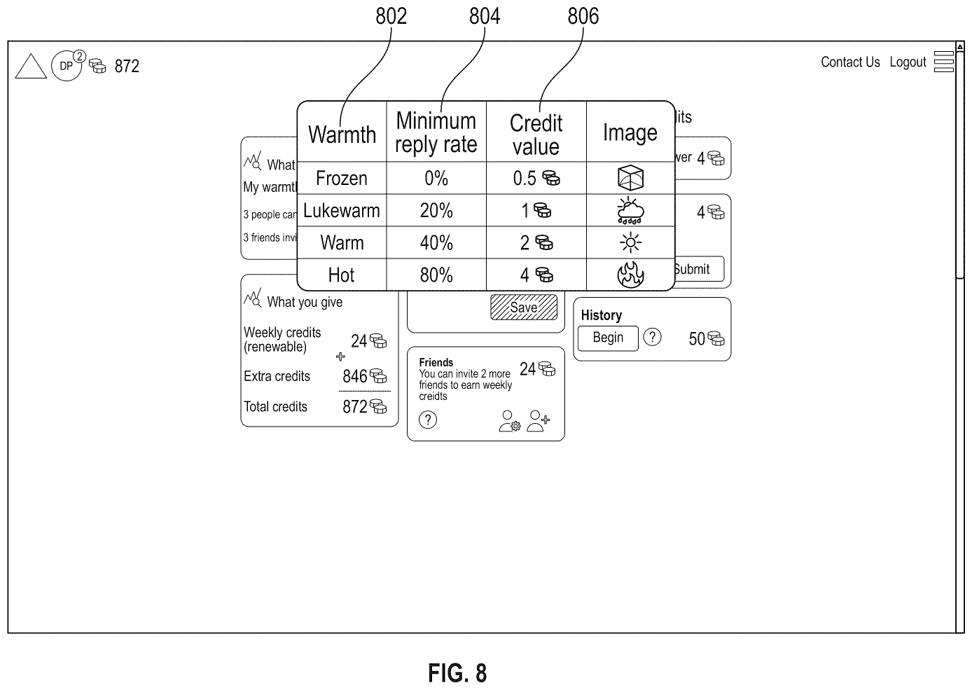

In accordance with aspects of the present disclosure, the due date for responding to the message is a date that is set by the communication platform to encourage active engagement between users. In various embodiments, the due date may be three days after receiving a message, five days after receiving a message, seven days after receiving a message, or another due date time period. A user gains benefits for reviewing and/or responding to received messages. Such benefits are described in connection with FIG. 6 and FIG. 7 below. For now, it is sufficient to note that a user receives benefits (e.g., digital credits) for responding to a received message within the due date (e.g., within seven days after receiving a message). In various embodiments, if a user responds to a received message after the due date, but within a certain time period after the due date (e.g., within eight to fourteen days after receiving a message), the user may receive half of the benefits (e.g., half of the digital credits). In various embodiments, if a user does not respond to a received message within the certain time period after the due date, the communication platform may delete the received message or otherwise make it unavailable or inaccessible to the user. This reduces the user's reply percentage of replying to received messages, which may result in a detriment to the user, as described below in connection with FIG. 8.

As mentioned above, a user can indicate a decision for each message. Options for the decision may include, for example, Yes, Remind me in 1 month, Remind me in 3 months, No, No and Block sender, and/or No and block sender and report offensive content, among other possibilities. By agreeing to connect with the message sender (i.e., Yes), the user's identity (e.g., full name), email address, contact information (e.g., telephone number), profile image (if provided), and/or company name (if previously undisclosed), will be provided to the message sender.

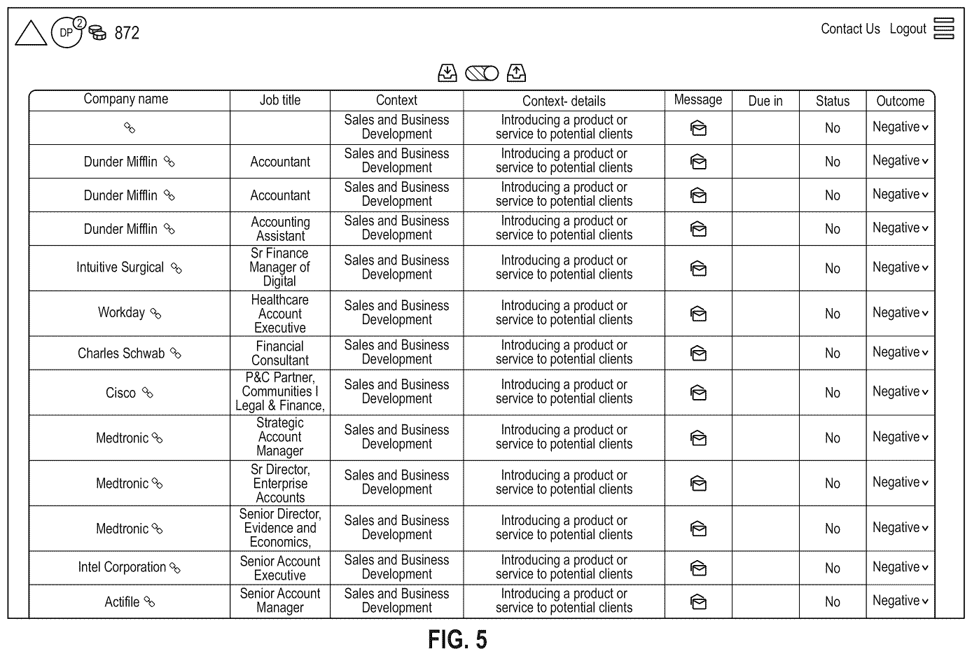

FIG. 5 is a diagram of an example of a display screen for interacting with a user's sent messages. The sent messages may include information such as message recipient's company name, message recipient's job title, context of the message, context details of the message, contents of the message, due date for message recipient to respond to the message, status of the message (e.g., opened or not), and the message's user engagement outcome. As mentioned above, context and context details of the message provide information about a sender's reason for sending a message and will be described in more detail in connection with FIG. 12.

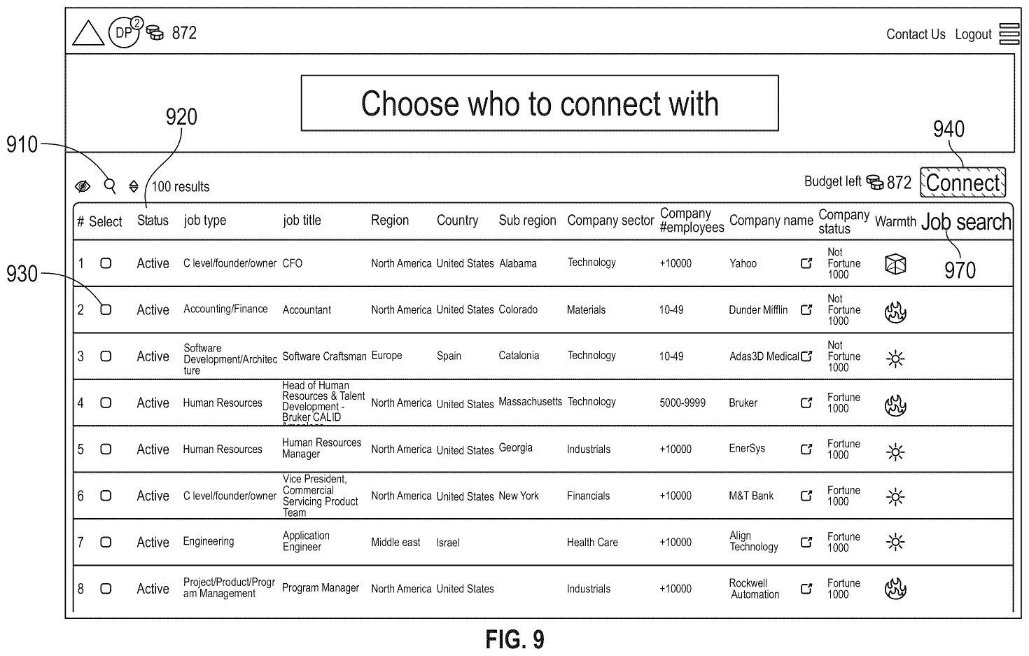

As shown in FIG. 5, the sent messages do not include the message recipient's identity. In accordance with aspects of the present disclosure, a user sending a message to a message recipient does not have access to the recipient's identity when sending the message and must decide to send the message based on other information about the recipient. Such other information will be described in connection with FIG. 9 and FIG. 10. In various embodiments, a user sending a message to a message recipient may also not have access to the recipient's company name when sending the message. For example, if the recipient's job title is CEO (or any C-level officer), there is only one such person per company and having the company name essentially reveals the identity of the recipient. In various embodiments, any C-level officer will have their company name hidden and non-searchable. In various embodiments, a user's choice of whether to make their company name available to other users may be selected in their privacy settings. In various embodiments, if the recipient's company has a small number of employees (e.g., 1-9 employees), the communication system may automatically hide the name of the company, as knowing the company name in combination with the recipient's job title and/or job type may lead to identifying the recipient.

The display screens of FIG. 4 and FIG. 5 are merely examples, and variations are contemplated to be within the scope of the present disclosure. For example, other information is contemplated to be within the scope of the present disclosure. Additionally, such information may be arranged differently than as those shown in FIG. 4 and FIG. 5. In various embodiments, the display screens may not include all of the information shown in FIG. 4 and FIG. 5. Such and other variations are contemplated to be within the scope of the present disclosure.

FIG. 6 is a diagram of an example of a display screen for setting degrees to which a user would like to utilize the communication platform and reflects digital resources (e.g., digital credits) available to the user, how they are computed, and how they can be obtained. The display screen of FIG. 6 shows a digital resource 602, such as digital credits or digital tokens. For convenience, the digital resource 602 may be referred to herein as digital credits, but it will be understood that other types of digital resources may be used. As described below, some of the digital credits 602 may be obtained on a recurring basis, and some of the digital credits 602 may be obtained on a one-time basis. In various embodiments, some of the digital credits 602 may be obtained on a paid basis.

In accordance with aspects of the present disclosure, a user can accumulate digital credits 602 in various ways, including accumulating digital credits on a recurring basis (e.g., per week) by agreeing to receive and review messages from other users. The display screen of FIG. 6 includes a setting 610 that a user can adjust to reflect how many messages the user would be willing to receive from other users, such as one message through five messages per week, or another number of messages. Messages are received by a user on a first-come-first-served basis up to the setting 610. Once the quota is reached, other users would not be able to send new messages to that user. In various embodiments, once a user's quota is reached, that user may no longer appear in searches by other users, which is described below in connection with FIGS. 9 and 10). In various embodiments, once a user's quota is reached, a status of the user is shown as “Full”, e.g., in the status column in the search results screen of FIG. 9. In the case of a user having a “Full” status, other users may still send messages to such user, but the sent messages will be queued until the user's quota is emptied or reset and may then be delivered to the user on a first-come-first-served basis. In various embodiments, the other users sending such messages may be informed of the expected waiting time before the message is delivered. In various embodiments, a user can choose that certain context(s) (e.g., job offers) will not be limited so that a user can receive an unlimited number of messages for those context(s).

In various embodiments, the user accumulates digital credits 602 for each message that the user is willing to receive. The number of digital credits (whole credits and/or fractional credits) that a user accumulates for each message is based on the user's warmth level, which is described below in connection with FIG. 8. In summary, the warmth level serves as a multiplier. In the illustrated display screen of FIG. 6, the user has agreed to receive three (3) messages per week, and if the user's warmth level is “Warm,” the multiplier is two (2) and the user can accumulate 3×2=six (6) digital credits per week. If the user's warmth level is “Frozen,” the multiplier can be 0.5 and the user can accumulate 3×0.5=1.5 digital credits per week. If the user's warmth level is “Hot,” the multiplier can be 4 and the user can accumulate 3×4=12 digital credits per week. The numbers of credits are merely examples, and other values for the number of credits accumulated and other formulas for computing the number of credits are contemplated to be within the scope of the present disclosure. A user can generally accumulate more digital credits by choosing to receive more messages, providing more answers, and/or providing more positive answers. Various formulas implementing such approaches are contemplated to be within the scope of the present disclosure. In various embodiments, users who have a warmth level of “Frozen” may receive 0.5 credits per week regardless of the number of messages they agree to receive. In such embodiments, this penalty for having a “Frozen” warmth level operates to discourage users from being in the “Frozen” warmth level.

In accordance with aspects of the present disclosure, and with continuing reference to FIG. 6, a user can accumulate the digital credits 602, on a one-time basis and a recurring basis, by inviting others, who are not part of the communication platform, to join the communication platform. The illustrated display screen includes a user interface element 670 for initiating the process of inviting others, who are not part of the communication platform, to join the communication platform. In various embodiments, the number of invitations a user can send per week can be limited, such as limited to three invitations per week, or another number of invitations per week. In various embodiments, the user can accumulate, on a one-time basis, a particular number of digital credits for each invitation that is sent to others who are not part of the communication platform, such as twelve (12) digital credits per invitation, or another number of digital credits per invitation. The illustrated display screen includes a user interface element 680 for viewing the status of invitations. FIG. 7 shows an example of a display of invitation status. As shown in FIG. 7, an accepted/approved invitation accumulates twelve (12) digital credits on a one-time basis, while a pending invitation does not accumulate digital credits.

In accordance with aspects of the present disclosure, a user may accumulate the digital credits 602 on a recurring basis based on invitees who have accepted/approved the user's invitation and joined the communication platform. Such invitees will be referred to herein as “joined invitees.” In various embodiments, a user accumulates digital credits 602 on a recurring basis based on the joined invitee's recurring digital credits. For example, if a user's joined invitee accumulates six (6) digital credits per week, the user may also receive six (6) digital credits per week for bringing that joined invitee to the communication system. Thus, as a user's number of joined invitees grows, the user also accumulates more digital credits on a recurring basis, thereby providing a strong incentive for users to invite others, who are not part of the communication platform, to join the communication platform.

In accordance with aspects of the present disclosure, and with continuing reference to FIG. 6, a user can accumulate digital credits 602 in other ways, including accumulating digital credits, on a one-time basis, by responding to a received message positively to agree to connect with the message sender (in which case the user's identity, email address, contact details, profile image (optional), and/or company name, will be shared with the message sender), by providing various information in the user's profile (e.g., uploading a profile image), and/or by providing various information in the user's educational and/or work history. As shown in the example of FIG. 6, a user, one a one-time basis, may receive four (4) digital credits 622 for positively responding to a received message to connect with the message sender, may receive four (4) digital credits 624 for uploading a profile image, and may receive fifty (50) digital credits 626 for completing their educational and/or work history information. In various embodiments, completing educational and/or work history information may require indicating an educational degree (e.g., high school diploma, college diploma, etc., which may be in-progress or may be obtained) and indicating at least two work experiences, which may include a current work experience and at least one prior work experience or may include at least two different roles within the same company, or may include two or more prior work experiences if a user is not presently working. The numbers of credits are merely examples, and other values for the number of credits accumulated are contemplated to be within the scope of the present disclosure.

The display screen can show information about digital credits attributable to number of messages that a user has agreed to receive and review from other users, invitations sent to others, responses to received messages to connect with message senders, and/or providing various information in a user profile and/or in work and/or educational history.

In accordance with aspects of the present disclosure, each user is assigned a warmth level. The display screen of FIG. 6 shows the warmth level of the user, and in the example of FIG. 6, the user has a warmth level of “Warm” 630. As shown in FIG. 8, a user can achieve warmth levels 802 on the basis of the user's reply percentage 804 of replying to received messages. If a user has a reply percentage below 20%, the user has a warmth level of “Frozen.” If a user has a reply percentage of at least 20% but below 40%, the user has a warmth level of “Lukewarm.” If a user has a reply percentage of at least 40% but below 80%, the user has a warmth level of “Warm.” And if a user has a reply percentage of at least 80%, the user has a warmth level of “Hot.” Each warmth level may be associated with a corresponding icon image. The number of warmth levels 802, the percentage ranges 804 for achieving the warmth levels, and the basis for the warmth levels are merely examples. Other numbers of warmth levels 802, other percentage ranges 804 for achieving the warmth levels, and other bases for the warmth levels are contemplated to be within the scope of the present disclosure.

In aspects of the present disclosure, the criteria for achieving a warmth level may be computed regularly. For example, in various embodiments, the criteria for achieving a warmth level (e.g., reply percentage 804) may be computed every seven days, every fourteen days, or every month, or at another time period interval. In various embodiments, the data for the computation may be based only on recent data (e.g., data from the past seven days, past fourteen days, past month, or another time period interval). In various embodiments, the data for the computations may be a combination of recent data and older data. In various embodiments, the data for the computations may be weighted such that older data may be accorded lesser weight than recent data, or older data may be accorded even weight than recent data, or older data may be accorded greater weight than recent data. In various embodiments, the computation of warmth level may apply a hysteresis approach, such that the criteria for demoting a user to a lower warmth level may be different from the criteria for promoting a user to a higher warmth level. Such and other embodiments for computing warmth level are contemplated to be within the scope of the present disclosure.

In accordance with aspects of the present disclosure, a user's warmth level 802 may affect the case by which others may contact the user. With continuing reference to FIG. 8, each warmth level is associated with a value of digital credit expenditure 806 needed to contact the user having the warmth level. For example, in the illustrated example of FIG. 8, for a user having a “Frozen” warmth level, other users wishing to contact the “Frozen” user would need to expend 0.5 digital credits to do so. Other users wishing to contact a “Lukewarm” user would need to expend one (1) digital credit to do so. Other users wishing to contact a “Warm” user would need to expend two (2) digital credits to do so. And other users wishing to contact a “Hot” user would need to expend four (4) digital credits to do so. The numbers of digital credits 806 needed to contact other users are merely examples, and other numbers are contemplated to be within the scope of the present disclosure.

In accordance with aspects of the present disclosure, a user's warmth level 802 may have no effect on the case by which others may contact the user. In such embodiments, the number of digital credits to contact the user may be constant regardless of the user's warmth level.

By implementing warmth levels 802 and different digital credit expenditures 806 for contacting users based on the recipients' warmth levels, a user can control certain aspects of their engagement with the communication platform. For example, a user wishing to be contacted only by serious users of the communication platform may look to achieve a “Hot” warmth level, thereby maximizing the cost for others to contact the “Hot” user. Because users accumulate digital credits over time and generally cannot accumulate vast numbers of digital credits all at once, users generally must budget their expenditure of digital credits. By imposing a significant cost to contact a “Hot” user, generally only serious users would expend the digital credits to reach out to a “Hot” user. On the flip side, a “Hot” user wishing to maintain the “Hot” warmth level would need to continue responding to at least 80% of received messages to maintain the “Hot” warmth level. This mechanism gives a message sender a degree of assurance that their message to a “Hot” user will most likely be opened and read.

On the other end of the spectrum, a user who responds to less than 20% of messages would have a warmth level of “Frozen.” By imposing only a nominal expenditure to contact a “Frozen” user, users may find it worthwhile to contact a “Frozen” user even if the chances of receiving a response are low. Due to the nominal expenditure of contacting a “Frozen” user, a “Frozen” user may not receive serious contacts from other users, especially when the number of messages a user agrees to receive per week is on the order of one message to five messages per week, for example.

In between a “Frozen” warmth level and a “Hot” warmth level, users having “Lukewarm” and “Warm” warmth levels should receive messages from a variety of users, including some serious users.

The display screens of FIG. 6, FIG. 7, and FIG. 8, are merely examples, and variations are contemplated to be within the scope of the present disclosure. For example, other information is contemplated to be within the scope of the present disclosure. Additionally, such information may be arranged differently than as those shown in FIG. 6, FIG. 7, and/or FIG. 8. In various embodiments, the display screens may not include all of the information shown in FIG. 6, FIG. 7, and/or FIG. 8. Such and other variations are contemplated to be within the scope of the present disclosure.

FIG. 9 is a diagram of an example of a display screen showing a search screen for searching and finding other users of the communication platform. The display screen includes a user interface element 910 for initiating a search for other users, which will be described below in connection with FIG. 10. The display screen of FIG. 9 includes a listing of users identified by the search.

The display screen provides various information about the users identified by a search, including, for example, user's active or inactive status, job type, job title, geographic region, country, country sub-region, company sector, number range of employees at the company, company name, link to company website, company status, user's warmth level, and whether the user is searching for a job. As mentioned above, in accordance with aspects of the present disclosure, users are not able to access the identity of other users in the search results display screen of FIG. 9. In various embodiments, users may also not be able to access the company name where other users presently work, in the search results display screen of FIG. 9. For example, if the recipient's job title is CEO (or any C-level officer), there is only one such person per company and having the company name essentially reveals the identity of the recipient. In various embodiments, any C-level officer will have their company name hidden and non-searchable. In various embodiments, a user's choice of whether to make their company name available to other users may be selected in their privacy settings. In various embodiments, if the company has a small number of employees (e.g., 1-9 employees), the communication system may automatically hide the name of the company, as having the name of the company in combination with another user's job title and/or job type may lead to identifying the other user.

A user's active or inactive status 920 may be indicated by wording, as shown in FIG. 9. In various embodiments, the status 920 may be accompanied by an icon (not shown). In various embodiments, an icon may be displayed near the status wording to indicate that the user is seeking a job. In various embodiments, an icon may be displayed near the status wording to indicate that the user is hiring for a job position. Other icons having other meanings are contemplated to be within the scope of the present disclosure.

The user's job type may indicate, for example, C level/founder/owner, accounting/finance, human resources, science/research, or project/product/program management, or any of the job types shown in the Example of Prompt above herein, or other job types. The user's job title may indicate any job title of the user, which may be a convention job title, such as CEO or CFO, etc., or may be a non-conventional job title, such as applied scientist or firmware architect, among other job titles.

The region may indicate, for example, Asia & Pacific, Europe, Arab States, Africa, South/Latin America, North America, Middle East, and/or South/Central America, or other regions. The country may indicate, for example, United States or Israel, or another country. The country sub-region may indicate, for example, the states or provinces of a country, or another country sub-region. In the case of the United States, for example, the country sub-region may indicate Alabama, Colorado, Minnesota, Massachusetts, Wisconsin, New York, or Virginia, or another state of the United States.

The company sector may indicate, for example, technology sector, materials sector, financial sector, retail sector, or industrial sector, or any of the company sectors shown in the Example of Prompt above herein, or other company sectors. The number range of employees at the company may indicate, for example, 1-9 employees, 10-49 employees, 50-249 employees, 250-999 employees, 1000-4999 employees, 5000-9999 employees, or 10000+ employees, among other number ranges of employees. The company name may indicate any name of the user's company, such as, for example, Yahoo, Dunder Mifflin, Ansys, Bruker, American Family Insurance, M&T Bank, Amazon, Rockwell Automation, or Apple, or another company name. The company status may indicate, for example, Fortune 500, Fortune 1000 (but not in Fortune 500), or Not Fortune 1000, or another company status.

The warmth level, as described in connection with FIGS. 6-8, may include Frozen, Lukewarm, Warm, and Hot, among other possible warmth levels.

The job search status 970 may indicate that the user is searching for jobs or that the user is not searching for jobs, or may indicate that the user is hiring, or another job search status. In various embodiments, an icon (not shown) may be displayed in the job search status 970 column corresponding to the desired indication. Users may selectively set their job search status 970, and the communication platform can display the appropriate icon corresponding to the user's setting.

As mentioned above, the users identified by the search are shown in the display screen of FIG. 9. To communicate with one of the identified users, the checkbox 930 next to such user may be selected, and the “Connect” button 940 may be engaged to initiate the process of sending a message to such user. Such operation will be described below in connection with FIG. 12. In various embodiments, multiple identified users may be selected by checking multiple checkboxes, and the same message may be prepared and sent to multiple users.

The display screen of FIG. 9 is merely an example, and variations are contemplated to be within the scope of the present disclosure. For example, other information is contemplated to be within the scope of the present disclosure. Additionally, such information may be arranged differently than as shown in FIG. 9. In various embodiments, the display screen may not include all of the information shown in FIG. 9. Such and other variations are contemplated to be within the scope of the present disclosure.

FIG. 10 is a diagram of an example of a display screen showing search parameters that may be configured to search for and find other users. The search display screen of FIG. 10 may be reached by engaging the search user interface element 910 of FIG. 9. The search parameters include parameters relating to an individual 1020, parameters relating to a user's company 1030, and parameters relating to a user's education 1040. The display screen includes a user interface element 1010 (e.g., a toggle element) that allows a user to configure “positive” search parameters and “negative” search parameters. As used herein, positive search parameters are search parameters that a search result must satisfy, and negative search parameters are search parameters that a search must not satisfy. In the example display screen of FIG. 10, the user interface element 1010 is set to positive search parameters, so that any search parameters entered into the display screen become positive search parameters. The user may toggle the user interface element 1010 to negative search parameters, so that any search parameters entered into the display screen become negative search parameters (not shown). A user may enter both positive search parameters and negative search parameters and conduct a search that simultaneously applies both positive and negative search parameters. As an example there can be a positive search parameter for the region Europe and a negative search parameter for the country France. In such an example, all the countries in Europe except for France would match this search example.

The search parameters relating to an individual 1020 may include a status parameter, a region parameter, a country parameter, a warmth level parameter, a job search status parameter, a job type parameter, a job title parameter, an average number of years per company parameter, an employed parameter, an unemployed parameter, time since changed company parameters, a skill parameter, a number of years of a skill parameter (not shown), an experience parameter, a time since changed position in current company parameters, and a role as a manager or as an individual contributor (not shown).

The status parameter may indicate active or inactive. The region parameter may indicate, for example, North America or Middle east, or another region. The country parameter may indicate, for example, United States or Israel, or another country. The warmth level parameter, as described in connection with FIGS. 6-8, may include Frozen, Lukewarm, Warm, and Hot, among other possible warmth levels. The job search status parameter may indicate searching for jobs or not searching for jobs, or another job search status. The job type parameter may indicate, for example, C level/founder/owner, accounting/finance, human resources, science/research, or project/product/program management, among other job types. The job title parameter may indicate any job title, which may be a convention job title, such as CEO or CFO, etc., or may be a non-conventional job title, such as applied scientist or firmware architect, among other job titles.

The average number of years per company parameter may indicate a number between zero and nine or may indicate greater than or equal to ten, or may indicate another number of another number range. In the case the searcher is a job recruiter, this search parameter allows the searcher to search for and find other users who are less likely to hop quickly from job to job and/or to exclude other users who are more likely to hop from job to job. The employed parameter may be selected to find users who are employed. The unemployed parameter may be selected to find users who are unemployed. The time since changed company parameters can indicate that a user has changed companies less than or equal to a specified number of days, months, or years, or greater than or equal or a specified number of days, months, or years. In the case the searcher is a job recruiter, this search parameter allows the searcher to search for and find other users who may be open to switching jobs and/or to exclude other users who may not be open to switching jobs (e.g., those who have been in the current job for a very long time). The skill parameter can indicate a particular skill. The number of years of a skill parameter (not shown) can indicate the number of years a user has for the particular skill. The experience parameter can indicate a particular experience. Examples of skills and/or experience include full stack development, WordPress, video game journalism, or construction safety, or other possible skills and experiences. The time since changed position in current company parameters can indicate that a user has changed positions within the current company less than or equal to a specified number of days, months, or years, or greater than or equal or a specified number of days, months, or years. In the case the searcher is a job recruiter, this search parameter allows the searcher to search for and find other users who may be open to switching jobs (e.g., those who have been in a current position and have not been promoted in a while).

The role of a user as a manager or individual contributor (not shown) may be used to search for and/or filter users who fit such roles. This search parameter allows the searcher to search/filter for and find other users who may be managers or individual contributors and/or were previously managers or individual contributors. Search parameters may include, for example, years of experience as a manager, years of experience as an individual contributor, number of cumulative years as a manager across all experiences, number of cumulative years as an individual contributor across all experiences, number of continuous years as a manager in latest experiences (e.g., in latest roles and/or jobs through current role/job), number of continuous years as an individual contributor in latest experiences (e.g., in latest roles and/or jobs through current role/job), number of cumulative years in a skill across all experiences, number of continuous years in a skill in latest experiences (e.g., in latest roles and/or jobs through current role/job), number of years (consecutive or cumulative) as a manager in latest X years of experiences, number of years (consecutive or cumulative) as an individual contributor in latest X years of experiences, number of years (consecutive or cumulative) in a skill in latest X years of experiences, percentage of time (consecutive or cumulative) as a manager across all years of experiences, percentage of time (consecutive or cumulative) as an individual contributor across all years of experiences, percentage of time as a manager in latest X years of experiences (e.g., at least 60% of time as manager in latest 5 years of experiences), percentage of time (consecutive or cumulative) as an individual contributor in latest X years of experiences (e.g., at least 60% of time as manager in latest 5 years of experiences), percentage of time (consecutive or cumulative) in a skill across all years of experiences, or percentage of time (consecutive or cumulative) in a skill in latest X years of experiences, where X>0 and the value of X is configurable. In various embodiments, a search for users who have experience(s) in a skill in the latest X years of experiences, may display search results which show the resulting users' full number of years of experience in the skill. For example, a search may search for users who have experience in a skill in the latest five (5) years of experiences. If a resulting user has ten (10) total years of experiences in the skill, the displayed search results for the resulting user may show ten (10) total years of experiences in the skill.

The search parameters relating to a user's company 1030 may include a company name, a company sector parameter, a number range of employees at the company parameter, a company status parameter, a company website available parameter, a number of years of work experience parameters, and a filtering parameter.

The company name may indicate any name of the user's company, such as, for example, Yahoo, Dunder Mifflin, Ansys, Bruker, American Family Insurance, M&T Bank, Amazon, Rockwell Automation, or Apple, or another company name. The company sector parameter may indicate, for example, technology sector, materials sector, financial sector, retail sector, or industrial sector, among other sectors. The number range of employees at the company parameter may indicate, for example, 10-49 employees, 5000-9999 employees, or 10000+ employees, among other number ranges of employees. The company status parameter may indicate, for example, Fortune 500, Fortune 1000 (but not in Fortune 500), or Not Fortune 1000, or another company status.

The company website available parameter may indicate whether the company has a website. The number of years of work experience parameters can indicate the number of years a user has worked, or may indicate a number range, such as greater than or equal to thirty (30) years, or another number of another number range. The filtering parameter may allow a user to select one of: don't filter by past 1032, filter past as current 1034, and filter past differently 1036.

In various embodiments, the don't filter by past selection 1032 is the default selection for the filtering parameter and means that the search parameters relating to a user's company information and individual information are searched only against users' current work experience or, for users who are presently not working, to such users' immediate prior work experience. For example, if another user had a title of CEO at a previous work experience and has a present title of COO at the present work experience, a search for other users having a title of CEO would not find such a user when the don't filter by past selection 1032 is applied.

In various embodiments, the filter past as current selection 1034 means that the search parameters relating to a user's company information and individual information are searched against users' entire work history so that if any single work experience matches the search parameter, such a user would be identified as matching the search. Continuing with the above example, a search for other users having a title of CEO would find the user who previously had or currently have a CEO title when the filter past as current selection 1034 is applied.

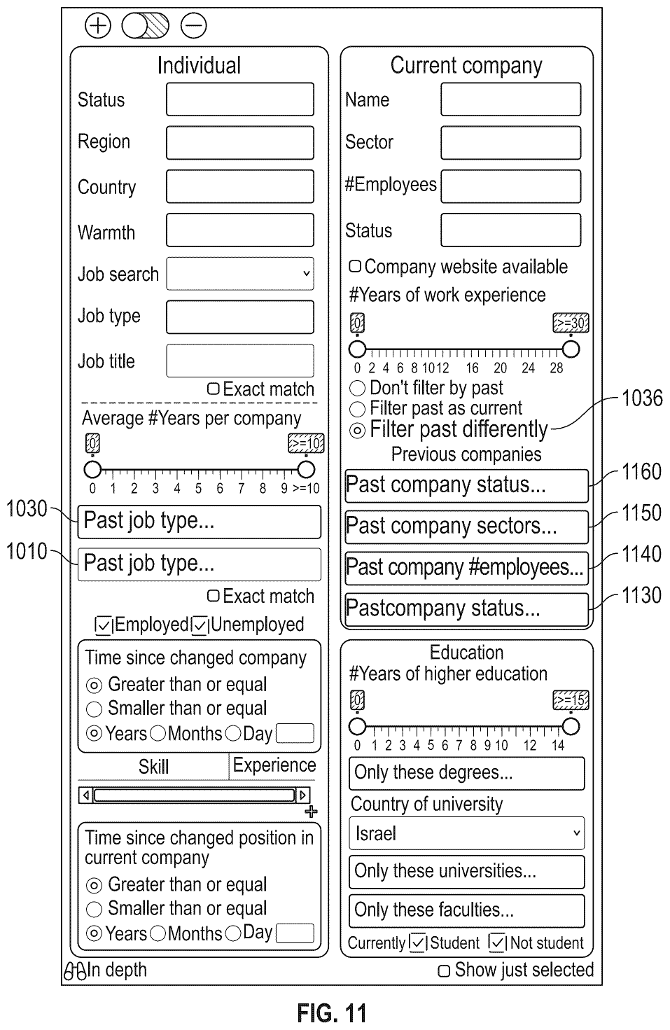

In various embodiments, the filter past differently selection 1036 enables a search that applies one set of search parameters for current work experience and a different set of search parameters for past work experiences. FIG. 11 is an example of a display screen when the filter past differently selection 1036 is selected. For example, if a search would like to find users who presently have a title of product manager and who previously in a past experience had a title of CEO, the display screen of FIG. 11 can be used to perform such a search. The search parameters available under the filter past differently selection 1036 may include past job title 1110, past job type 1120, past company name 1130, past company number of employees 1140, past company sectors 1150, and/or past company status 1160, among other possibilities.

With continuing reference to FIG. 10, the search parameters relating to a user's education 1040 may include a number of years of higher education parameter (e.g., education beyond high school), one or more educational degree parameters, a country of university parameter, one or more university name parameters, one or more degree faculty parameters, a current student parameter, and a not-current-student parameter.

The number of years of higher education parameter may indicate a number from zero to fourteen, or may indicate greater than or equal to fifteen, or may indicate another number of another number range. The one or more education degree parameters can indicate one or more degrees, such as Bachelor of Science degree, Bachelor of Arts degree, Master of Science degree, Master of Business Administration degree, Juris Doctor degree, or PhD degree, or any of the degrees shown in the Example of Prompt above herein, or other educational degrees. The country of university parameter can indicate a country where the user attended university. The one or more university name parameters may indicate one or more names of universities. The one or more degree faculties degree may indicate one or more fields of study, such as mathematics, computer science, physics, chemistry, biology, linguistics, history, or philosophy, or any of the faculties shown in the Example of Prompt above herein, or other fields of study. The current student parameter may be selected to search for users who are current students. The not-current-student parameter may be selected to search of users who are not current students.

After one or more of the search parameters are selected, a search can be executed, and users identified by the search can be shown in the display screen of FIG. 9. As mentioned above, in accordance with aspects of the present disclosure, users are not able to access the identity and/or the company name of other users in the search result display screen of FIG. 9.

In accordance with aspects of the present disclosure, rather than manually entering search parameters in the display screen of FIG. 10, a user may engage a search feature (not shown) to find other users who are similar to the user. Implementations of such a search feature are described in the following paragraphs.

As described above, the communication platform may have information about users relating to any of the information described herein, such as any of the information described or shown in connection with FIGS. 2-11. Accordingly, the communication platform may have a vast amount of information about users. In accordance with aspects of the present disclosure, the communication platform can define a distance metric that quantifies how similar two users are to each other based on the information about the two users, such as based on any of the information described or shown in connection with FIGS. 2-11. The distance value between a user and himself/herself would be zero (0). The communication platform can evaluate the distance metric for different pairs of users to quantify how similar any two users are to each other. Two users having greater differences in information would result in larger distance values, and two users having lesser differences in information would result in smaller distance values. As described below, the distance values for pairs of users can be determined by rule-based algorithms and/or by a machine learning/deep learning model which, given two users and their information, provide an output distance value.

In a rule-based approach, some information about users is numerical (e.g., average number of years per company, number of years for a skill, etc.). The distance between such numerical information can be a norm loss, such as the absolute value of the difference between two numerical values or any other loss function which penalizes for differences between two numerical values.

Some information about users is categorical, which means information values are selected among a set of discrete options. For example, job titles may be CEO, COO and sales manager, among other options. In a rule-based approach, there are various approaches for determining distances for categorical information. One approach is a binary approach in which if the job titles are the same, then the distance is zero (0), but otherwise the distance is one (1). Another approach uses job type so that if the job titles are different (e.g., CEO and COO) but they are of the same job type (e.g., C-level officer), then the distance may be between 0 and 1. Thus, for example, since CEO and COO are both from the C-level officer job type, they should have a distance between 0 and 1 even though the job titles are not the same. In various embodiments, for each categorical information, the distance between different job titles of the same job type may be defined.

In a rule-based approach, weights may be assigned to individual information distances, and the overall distance value between two users may be computed as a weighted sum of the individual information distances. Some information may be more important than other information, and various information may be assigned different weights that reflect their importance. For example, difference in job type may be more significant than difference in the number of employees in the current company, for measuring similarity between two users. Accordingly, the distance value for the job type may be assigned a greater weight than the distance value for the number of employees.

For the machine learning/deep learning model, the information of pairs of users and their ideal/ground truth distance is provided, and an embedding vector for each user is calculated. In various embodiments, the ideal/ground truth distance value between two users can be provided manually by a human as training data for training the machine learning/deep learning model. In various embodiments, the ideal/ground truth distance may be generated by the communication platform based on user interactions with the search results in the search results display screen (e.g., FIG. 9) provided by the rules-based approach. For example, the rules-based approach provides search results for the feature of finding other users who are similar to the user. The user viewing the search results may choose to take a look into certain search results, may choose to send messages to certain search results, and may choose not to look into certain other search results. Such interactions may be used by the communication platform to generate ground truth distances. For example, the search results which a user chooses to message with the context detail as “Connecting with someone like me” (as described in connection with FIG. 12 below) will have a very low distance (almost 0 since 0 is reserved for identity), the search results which a user chooses to message with certain other context details may have a various distances, the search results which a user chooses to look into but not to message will have a higher distance, and the search results which a user does not even look into will have the highest distance. Such distances may be generated by the communication platform and used as ground truth data for training the machine learning model.

When there is sufficient training, the machine learning model may be used to provide search results for the feature of finding other users who are similar to the user. Using a trained machine learning/deep learning model, information for two users may be input to the trained model, and the trained model would output the distance value between the two users. Two users whose distance is sufficient low (e.g., based on a threshold) may be included in the search results. Then, user interactions with such search results may be further used to produce ground truth distances for further training the machine learning model. This process can be iterated as a learning loop (continuous or intermittent) which iteratively improves the accuracy of the machine learning model.

In various embodiments, a threshold value can be applied to the distance value between two users to determine whether two users are similar. For example, the communication platform can determine that another user is similar to a user if the distance value between them is below the threshold value. In various embodiments, the threshold value can be adjustable. In the manner described above, a user can engage a search feature (not shown) to find other users who are similar to user.

In accordance with aspects of the present disclosure, the search conducted by the communication platform may be an intelligent search that takes into account prior searches by a user and avoids providing results that a user has already reviewed. For example, when searching for other users, a user may review the results of a search and, in a later search, review the same results again. In various embodiments, the communication platform may monitor which search results were presented to the user and monitor whether the user reviewed the search results (e.g., by screen time that a search result was on the screen, by whether a search result was ever visible on a screen, by mouse cursor activity, etc.). In various embodiments, for results that were already reviewed, the communication platform can avoid presenting such results again to the user. The feature to exclude previously reviewed search results may be enabled or disabled by a user. For example, such feature may be a search parameter in the display screen of FIG. 10. In various embodiments, results that were already reviewed may be displayed with an indication (e.g., an icon) to indicate that the result was already reviewed. In various embodiments, results that were already reviewed may be displayed later in the search results and/or displayed at the end of the search results.

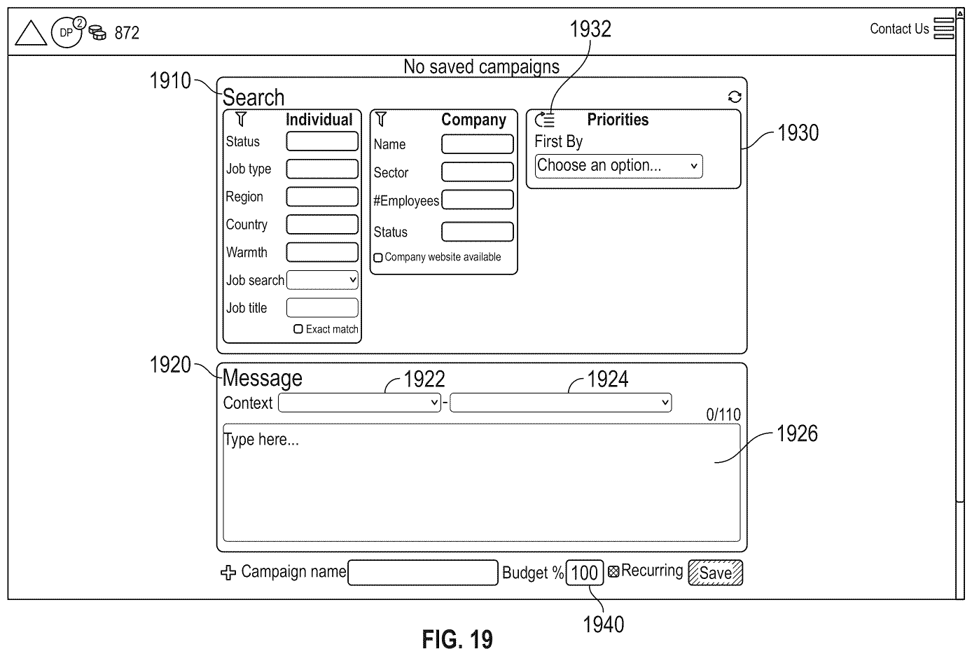

In various embodiments, the determination of search results as already reviewed can be specific to a context, a sub context, and/or to a campaign (which will be described in connection with FIG. 19). For example, if a user searches for other users in the context of searching for a job and, later, the user searches for other users in the context of selling a product, the two searches have different context, so search result in the later search should be presented to the user in the usual manner even if the user reviewed the same search results in the earlier search. For a campaign, a user may search for something different in each campaign. For example, the user may be a job recruiter, and different campaigns can represent different job positions the job recruiter is hiring for. Search results which were already reviewed for one job position should still be presented as a search result for a different job position.

In accordance with aspects of the present disclosure, the communication platform may monitor a user's review of the search results shown in FIG. 9 and may automatically recommend search parameters based on the user's review activity. When the user is reviewing the search results of FIG. 9, the user will either select a result that is displayed on the screen or keep scrolling and not select a result. In case of the latter, the user is passively making a choice by continuing to scroll. A selected result is a positive example of a search result that interests the user, and a non-selected result is a negative example of a search result that does not interest the user. In accordance with aspects of the present disclosure, a machine learning model and/or a statistical model may use the positive examples and the negative examples to identify new search parameters (e.g., positive search parameters or negative search parameters) and to automatically suggest them to the user, who can choose whether to add the suggested search parameters and modify the search. In the case of a machine learning (ML) model, the ML model can be a classical ML model, such as a support vector machine (SVM), random forest, etc., which receives a vector of features that represents the information that the user sees when they conduct the manual search. Information which was not visible to the user while conducting the manual search would not be part of the vector because a user does not make any decision based on information they did not see. In various embodiments, when there is a significant amount of data for training, the ML model may be a deep learning model. In accordance with aspects of the present disclosure, the ML model may be trained in real-time as a user scrolls and clicks through search results. The training may be executed in the background (e.g., in the communication system) after enough examples are available, and the trained ML model can provide suggestions to the user while the user is conducting the search and reviewing search results.

The display screens of FIG. 10 and FIG. 11 are merely examples, and variations are contemplated to be within the scope of the present disclosure. For example, other information is contemplated to be within the scope of the present disclosure. Additionally, such information may be arranged differently than as shown in FIG. 10 or FIG. 11. In various embodiments, the display screen may not include all of the information shown in FIG. 10 or FIG. 11. Such and other variations are contemplated to be within the scope of the present disclosure.

FIG. 12 is a diagram of an example of a display screen showing a window for sending a message to a user that was found in the search screen of FIG. 9. As mentioned above, the window of FIG. 12 may be reached by selecting a particular search result in the display window of FIG. 9 and then engaging the “Connect” button 940.

The window includes a context field 1210 and a context details field 1220. As mentioned above, the context and context details provide information about a sender's reason for sending a message. In various embodiments, the context field 1210 and the context details field 1220 are populated with predetermined selections, and a user may only select one of the predetermined selections. In various embodiments, a user may input any text in the context field 1210 and/or the context details field 1220. The user may enter any text message in the message field 1230. When the message is completed, the user can engage the “Submit” button to send the message.

In various embodiments, the predetermined selections for context and corresponding context details may include the examples shown in the following. The examples are merely illustrative, and other context and context details are contemplated to be within the scope of the present disclosure.

| Context | Possible Context Details |
|---|---|
| Networking | Reaching out to potential business partners |
| | Seeking mentorship or advice from |
| | experienced individuals |
| | Connecting with professionals in your |
| | industry |
| | Connecting with someone like me |
| Job Opportunities | I am searching for a job opportunity for |
| | myself |
| | I am hiring for an open position |
| Sales and Business | Introducing a product or service to potential |
| Development | clients |
| | Exploring new business opportunities |
| | Establishing partnerships with other |
| | businesses |
| Marketing | Promoting a new product or service |
| | Announcing company updates or events |
| | Seeking collaboration on marketing |
| | initiatives |
| Research and | Conducting market research |
| Surveys | Requesting participation in a survey or |
| | study |
| Content | Proposing collaboration on content creation |
| Collaboration | Requesting to feature someone in your |
| | content |
| | Inviting influencers to collaborate on a |
| | project |
| Education and | Inviting individuals to attend a workshop or |
| Training | training session |
| | Promoting educational resources or courses |
| | Seeking partnerships for educational |
| | programs |
| Event Invitations | Inviting someone to attend an event or |
| | conference |
| | Requesting participation in a webinar or |
| | online event |
| Feedback and Testimonials | Requesting feedback on a product or |
| | service |
| | Asking for testimonials or case studies |
| Nonprofit and | Requesting donations or support for a cause |
| Charity Initiatives | Seeking volunteers for a charitable event |
| Media and Press | Pitching a story idea to journalists or media |
| | outlets |
| | Requesting coverage for a product launch |
| | or event |
| Introductions and | Requesting recommendations or referrals |
| Recommendations | Seeking introductions to key individuals in |
| | your industry |

In various embodiments, the communication system can automatically suggest a message based on a user's previous messages, based on previous messages that resulted in a successful connection, based on the context that is selected, and/or based on the sub-context that is selected.

A user's sent message can be accessed in the sent messages display screen, such as the display screen shown in FIG. 5. A user who receives a message can access received messages in a received messages display screen, such as the display screen shown in FIG. 4.

The display screen of FIG. 12 is merely an example, and variations are contemplated to be within the scope of the present disclosure. For example, other fields are contemplated to be within the scope of the present disclosure. Additionally, such fields may be arranged differently than as shown in FIG. 12. In various embodiments, the display screen may not include all of the fields shown in FIG. 12. Such and other variations are contemplated to be within the scope of the present disclosure.

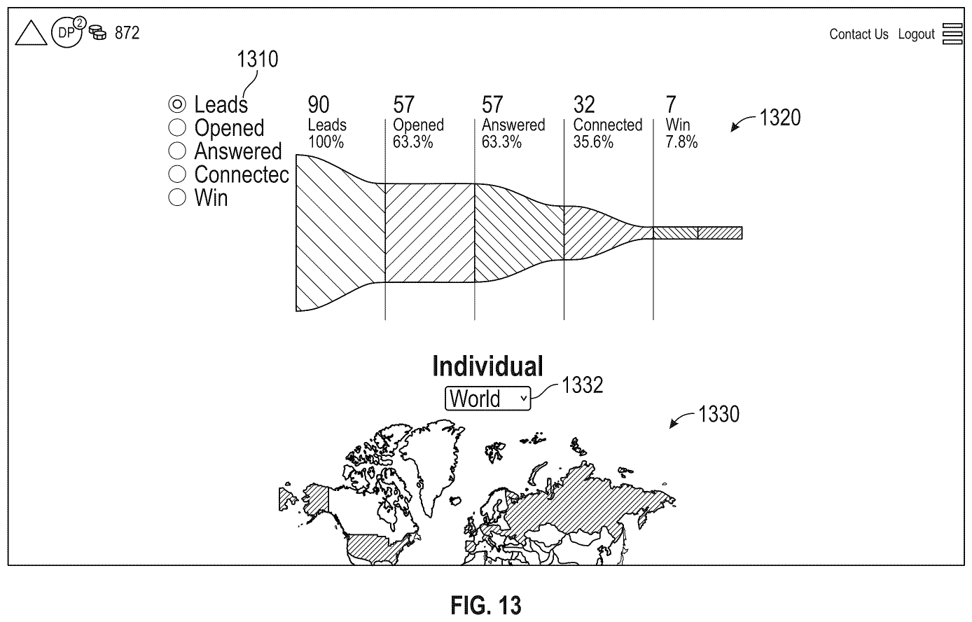

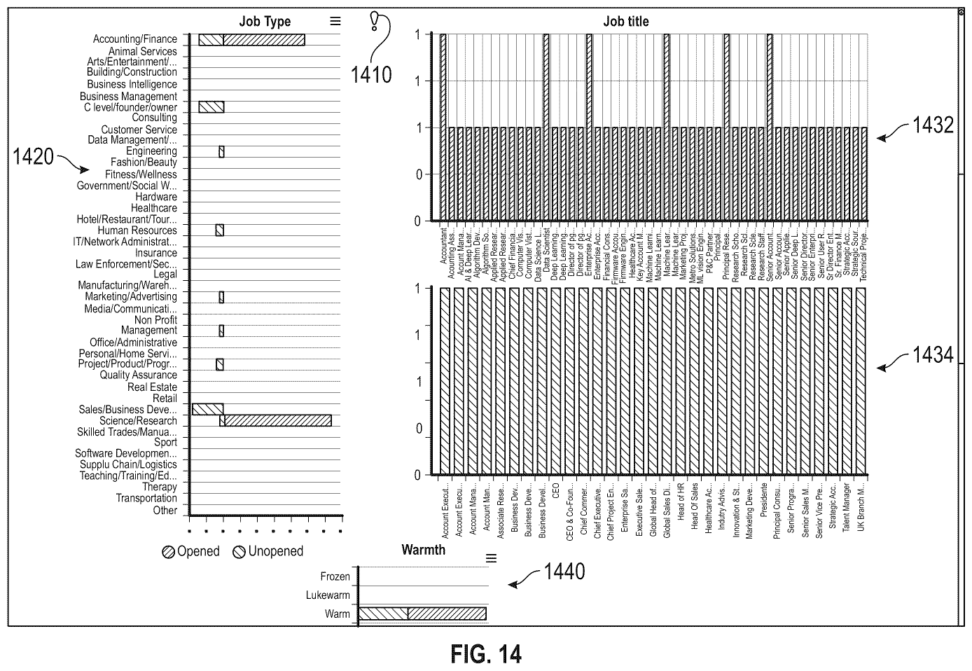

Display screens for finding, communicating, and connecting with other users were described above. The following will describe display screens showing analytics, in connection with FIGS. 13-17. Various display screens in FIGS. 13-17 may include an exclamation mark (e.g., 1410, FIG. 14). Such an indication is provided when an analysis reveals that certain information has a meaningful benefit or detriment to the user when that information has a certain value. The exclamation mark is merely an example, and the indication can be another icon or another indication.

FIG. 13 is a diagram of an example of a display screen showing analytics indicating progress in communicating and connecting with other users of the communication platform. In accordance with aspects of the present disclosure, the progress in communicating and connecting with other users can have defined phases 1310, such as a leads phase capturing other users who are leads for a user to connect with, an opened phase capturing other users who have received and opened a message from the user, an answered phase capturing other users who have answered a message from the user, a connected phase capturing other users who have connected with the user, and a win phase capturing other connected users who, according to the user who sent the message(s), have provided a benefit to the user. The analytics can show the number and percentage 1320 of other users in each phase, as numbers and/or as a graphic.

In the display screen of FIG. 13, the analytics can also show a geographic map 1330 of countries of the world or of regions and can indicate the countries where other users are located. The other users captured in each phase can be separately visualized in the geographic map 1330 of countries or regions. For example, in FIG. 13, the opened phase is selected, so the geographic map 1330 indicates the countries of the other users captured in the opened phase. When a user selects another phase, the geographic map 1330 and indications in the map are updated to reflect the locations of other users captured in the selected phase. In various embodiments, a user interface element 1332 allows the user to designate more granular regions. For example, the user interface element 1332 may allow a user to select a geographic map region (e.g., North America, Europe, etc.), and the display screen can show countries of the selected geographic map region. In various embodiment, the user interface 1332 element may allow a user to select a particular country (e.g., United States), and the display screen can show sub regions of the selected country, such as the states or provinces of the country. Other levels of granularity are contemplated to be within the scope of the present disclosure.

FIG. 14 is a diagram of an example of a display screen showing further analytics relating to individual characteristics of other users. The display screen of FIG. 14 can show analytics 1420 of number of users of each job type who opened a message from the user and number of users of each job type who did not open a message from the user. The display screen can also show analytics of number of users of each job title who opened a message from the user 1432 and number of users of each job title who did not open a message from the user 1434. The display screen can also show analytics 1440 of number of users of each warmth level who opened a message from the user and number of users of each warmth level who did not open a message from the user.

The display screen of FIG. 14 includes an exclamation mark 1410. As mentioned above, such an indication is provided when an analysis reveals that certain information has a meaningful benefit or detriment to the user when that information has a certain value. The exclamation mark is merely an example, and the indication can be another icon or another indication.

In accordance with aspects of the present disclosure, the determination of whether certain information has a meaningful benefit or detriment to a user can be implemented by statistical models, by machine learning models (classical and/or deep learning), or by a combination of statistical models and machine learning models. In various embodiments, the approach can evaluate each information separately, such as evaluating job type separately from evaluating job title, as shown in the example of FIG. 14. In various embodiments, the approach can evaluate multiple information or all information together to identify which information values are impactful (e.g., for a positive or negative outcome for each of the four stages of the message-opened, answered, connected, won) and to identify the direction of the impact. For example, the analytics can determine that if the value of a numerical information is higher, does this higher value increase or decrease the probability of a positive or negative outcome. An exclamation mark 1410 or other indicator can be displayed for information which is determined to have a meaningful benefit or detriment for the user. A user may engage the exclamation mark 1410 (or other indicator) to access further details on how the information impacts the user, such as details on the direction of the impact compared to the direction of the information values.

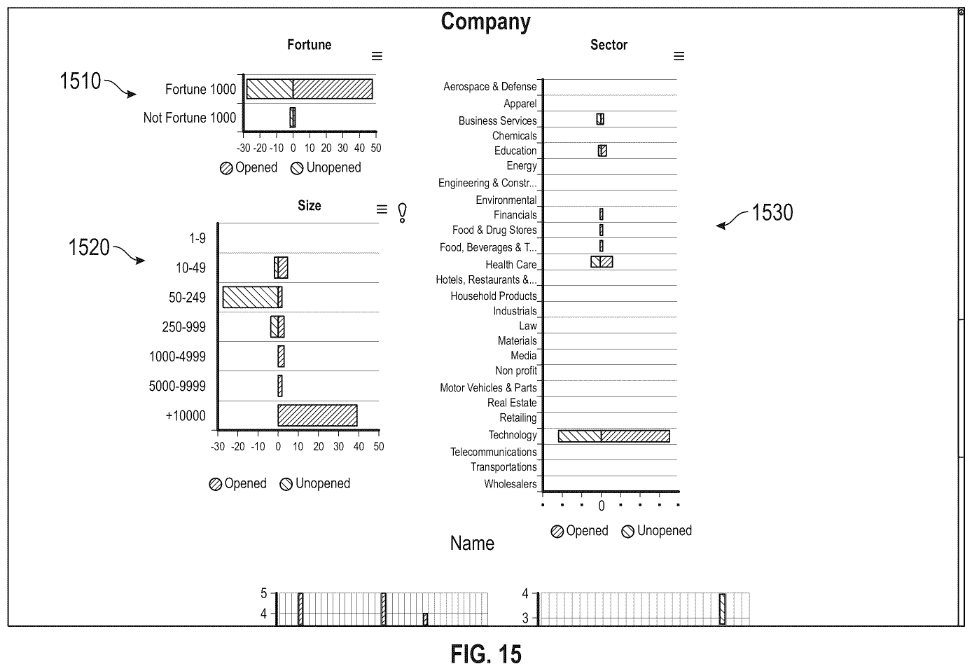

FIG. 15 is a diagram of an example of a display screen showing further analytics relating to company information of other users. The display screen of FIG. 15 can show analytics 1510 of number of users of each company status (e.g., Fortune 1000 company, or not Fortune 1000 company) who opened a message from the user and number of users of each company status who did not open a message from the user. The display screen can also show analytics 1520 of number of users of each company employee range who opened a message from the user and number of users of each company employee range did not open a message from the user. The display screen can also show analytics 1530 of number of users of each company sector who opened a message from the user and number of users of each company sector who did not open a message from the user.

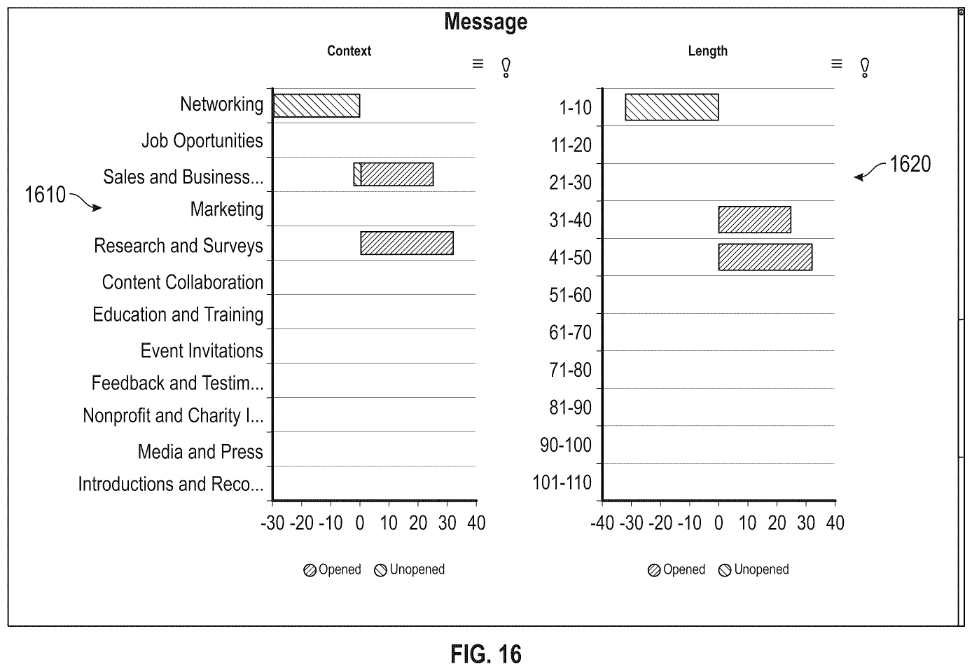

FIG. 16 is a diagram of an example of a display screen showing further analytics relating to message characteristics of messages communicated to other users. The display screen of FIG. 16 can show analytics 1610 of number of sent messages of each context that were opened by the recipient and number of sent messages of each context that were not opened by the recipient. The display screen can also show analytics 1620 of number of sent messages of each message length range that were opened by the recipient and number of sent messages of each message length range that were not opened by the recipient.

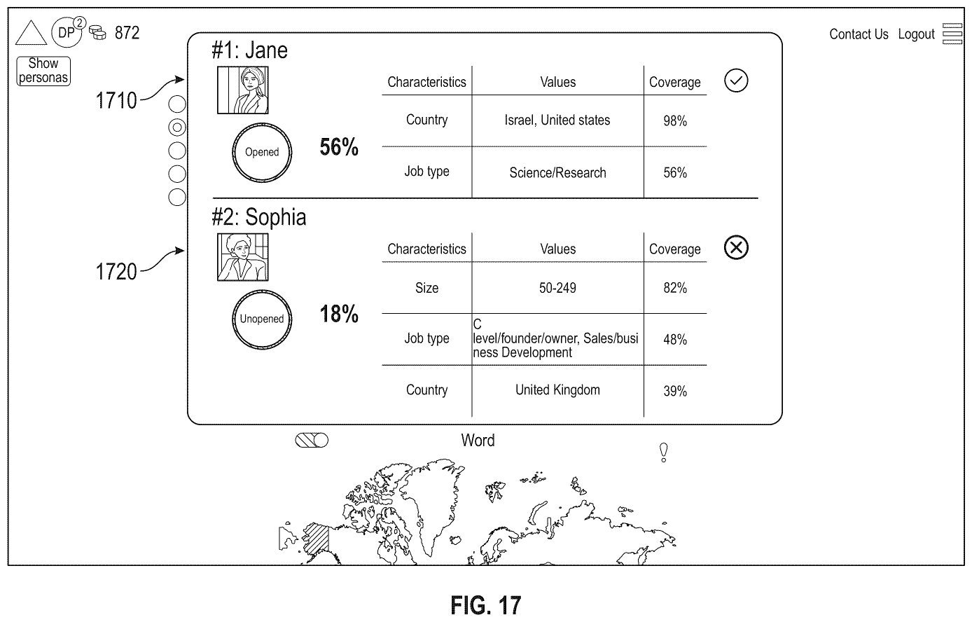

FIG. 17 is a diagram of an example of a display screen showing further analytics relating to personas of other users who engaged with or did not engage with a user. The names of the personas are merely fictitious names assigned to the personas. In the example of FIG. 17, in the persona 1710 of recipients who opened a message from the user (56% of such recipients opened a message from the user), 98% of such recipients were located in Israel or the United States, and 56% of such recipients had a job type of science/research. In the persona 1720 of recipients who did not open a message from the user (18% of such recipients did not open a message from the user), 82% of such recipients were from companies having employee range of 50-249 employees, 48% of such recipients had job types of C level/founder/owner, or sales/business development, and 39% of such recipients were from the United Kingdom. The information shown in the personas 1710, 1720 is merely an example. The personas can show any of the information shown in any of the FIGS. 2-16 and/or any of the information described above. In various embodiments, only information matching more than a certain threshold of other users (e.g., more than 35% of other users, more than 50% of other users, or another threshold value) are included in the personas. In various embodiments, personas involve only information that has a meaningful impact for the user, and such information may be identified by the approaches described above in connection with FIG. 14 for displaying an exclamation mark. Such information will be referred to as “significant features.”

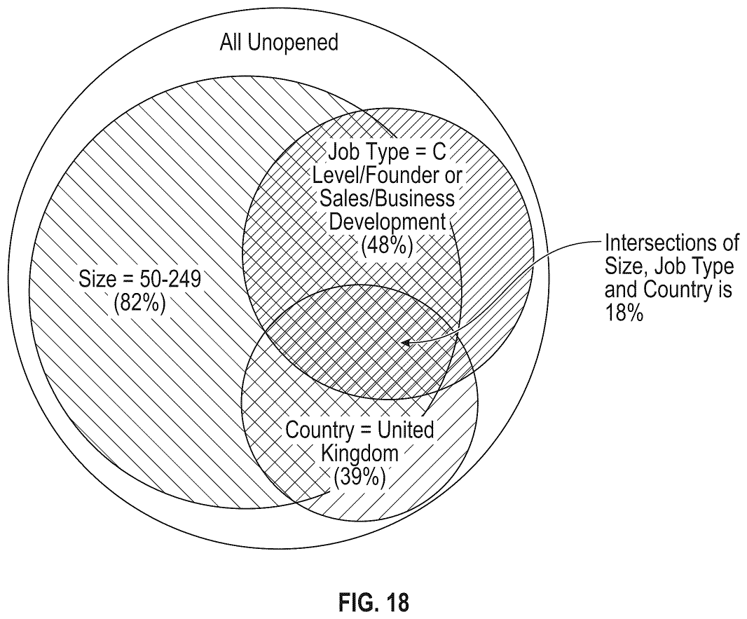

In various embodiments, the approach for determining personas uses significant features and uses a clustering algorithm to find the minimal number of clusters and information which represent as much of either the positive or negative outcome. For 18 shows an example of the significant features and percentages which form the negative persona of FIG. 17. In the group of all recipients who did not open a message from the user, as mentioned above and as shown in FIG. 18, 82% of such recipients were from companies having employee range of 50-249 employees, 48% of such recipients had job types of C level/founder/owner, or sales/business development, and 39% of such recipients were from the United Kingdom. The intersection of all such users accounts for 18% of all recipients who did not open a message from the user, and such intersection forms the negative persona 1720 of FIG. 17.

Each persona is common to a percentage of the positive or negative outcomes. Each outcome can have multiple personas which can be presented sorted from the largest portion of the outcome to the smallest. At a certain percentage of coverage, personas are no longer formed. All the characteristics and their percentages out of the outcome are presented, as shown in FIG. 17. The intersection of all the characteristics and their values is the coverage of the persona.

In various embodiments, the user can select a subset of the characteristics of a persona and see how this affects the coverage of the persona. For example, referring to FIG. 18, removing a characteristic would increase the coverage of recipients who did not open a message from the user to greater than 18%. The user may save the new definition of the persona. In various embodiments, a user may manually build a persona. Similar to the example of FIG. 18, a user may manually add or remove certain characteristics to the persona and see the percentage in the intersection of all included characteristics. There is a balance between adding more characteristics for a persona and decreasing the intersection percentage, and removing characteristics from a persona and increasing the intersection percentage. Generally, a persona should not include multiple characteristics that have only minor percentage difference between them, nor should a persona represent only a small percentage of the population. Once a persona is saved, the user can search either manually or automatically in a campaign for other users who match the saved persona.

The display screens of FIGS. 13-17 are merely examples, and variations are contemplated to be within the scope of the present disclosure. For example, other information and analytics are contemplated to be within the scope of the present disclosure. Additionally, such information and/or analytics may be arranged differently than as shown in FIGS. 12-16. In various embodiments, the display screens may not include all of the information and analytics shown in FIGS. 13-17. Such and other variations are contemplated to be within the scope of the present disclosure.

FIG. 19 is a diagram of an example of a display screen showing a messaging automation tool for automatically sending messages to other users. The messaging automation tool may be referred to herein as a “campaign.” As mentioned above, because users accumulate digital credits over time and generally cannot accumulate vast numbers of digital credits all at once, users generally must budget their expenditure of digital credits. A user may wish to connect with all other users resulting from a particular search or matching a particular persona, but doing so may require an amount of digital credits accumulated over time, such as over weeks or months.

In accordance with aspects of the present disclosure, the automation tool of FIG. 19 allows a user to select a persona or to set search parameters 1910, such as any combination of the search parameters shown in FIG. 10 and/or FIG. 11 or described above herein, and to set a default message 1920 that includes a selected context 1922, a selected context detail 1924, and message text 1926. The automation tool may then automatically send the default message 1920 to recipients identified by the selected persona or by the search parameters 1910 over time as the user accumulates digital credits over time.

In various embodiments, the user can specify priorities 1930 in the display screen of FIG. 19. A priority may be based on any of the search parameters shown in FIG. 10 and/or FIG. 11 or described above herein. In various embodiments, a user interface element 1932 may be engaged to add additional priority levels. In various embodiments, any number of priority levels may be added.

In various embodiments, a user interface element 1940 allows the user to specify number of digital credits or percentage of a user's digital credits to expend each week or each month, or over another time period.

The display screen of FIG. 19 is merely an example, and variations are contemplated to be within the scope of the present disclosure.

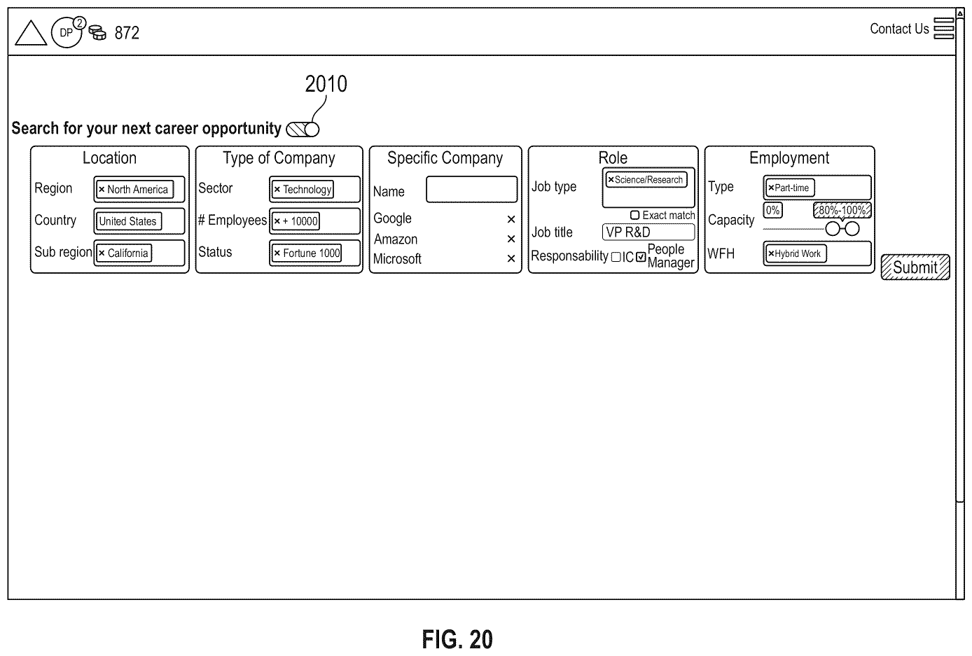

Referring to FIG. 20, there is shown a display screen for a feature for users to search for a career opportunity. Users who are seeking a job can engage a user interface element 2010 set their account to be open to career opportunities and can specify parameters for the career opportunity they are looking for. The user may set parameters that include, for example, as shown in FIG. 20:

1. Desired Location, which may include region, country, and sub region, which were described above herein. In various embodiments, if a user specifies his or her city of residence, the user may also specify distance from home as a parameter. The communication platform may incorporate travel time in certain periods of a day (e.g. mornings, afternoons, etc.).

2. Desired Type of Company, which may include sector, number of employees, and status, which were described above herein. In various embodiments, the user may set private or public company as a parameter.

3. Desired Company names of specific companies.

4. Desired Role, which may include job type and job title. With regard to job title, since there are a large number of possible job titles, an exact match may be difficult to find. In various embodiments, a large language model (LLM) machine learning model may estimate how close a job title is to an open position and/or whether the job title the job seeker requested matches an open position. In various embodiments, the role may also specify a desired responsibility, such as responsibility as an individual contributor or responsibility as a people manager.

5. Desired Employment, which may include type of employment (e.g., Full-time, Part-time, Self-employed, Freelancer, Contractor, Internship, Apprenticeship, Seasonal, etc.), capacity of work (e.g., percent of time working, where 100% is Full-time), and work from home policy (e.g., always on site, hybrid (including percentage at the office), and fully remote, etc.).

In various embodiments, a user may specify desired financial situation of a company, which the communication platform may access based on publicly available information. For public companies, the desired financial situation may include, for example, information such as stock price (current and/or historical). For private companies, desired financial situation may include, for example, funding history.

For users looking to hire, they will be able to base their search on parameters relating to what a user has done, is currently doing, and/or is looking for in their next role (e.g., as shown in FIG. 20). The parameters configurable by such users looking to hire may include (not shown), type of work (e.g., Full-time, Part-time, Self-employed, Freelancer, Contractor, Internship, Apprenticeship, Seasonal, Student, etc.), capacity of work (e.g., percent of time working, where 100% if full-time), work from home policy (e.g., always on site, hybrid (including percentage at the office) and fully remote, etc.), acceptable locations for a user and/or distance from a user's residence to work location (which can incorporate travel time in certain hours (e.g. mornings and afternoons)), and/or any or all of the information shown and described in connection with FIG. 11, including positive and/or negative search parameters.

In aspects of the present disclosure, a user seeking a job can configure more than one parallel searches for a next career opportunity, such as multiple of the configurations shown in FIG. 20. In aspects of the present disclosure, a user hiring for a position can configure more than one parallel searches finding a new hire.

When a new job is posted or a user updates they are searching for a certain job (e.g., new search configuration or a modified existing search configuration), the communication platform may determine whether there is a match between the job requirements and the desired job configurations of job seekers. In various embodiments, the communication system may perform such matching regularly at certain intervals of time. If a match is found between a job seeker and a job position, the communication platform may automatically connect the job seeker with the user posting the job position, and may automatically send information (such as the CV of the job seeker) to the hiring side. In various embodiments, the job seeker may receive information, such as a full job description before approving to share their CV with the hiring users.

In various embodiments, a job seeker may choose their desired monthly and/or annual salary (and set currency). On the hiring side, the users posting a job position may set a range for their hiring budget for the job position. In various embodiments, the job seeker and the user posting the job position may be connected only if there is a match between the desired salary and the hiring budget for the job position.

FIG. 20 and the description above are merely examples, and variations are contemplated to be within the scope of the present disclosure.

Accordingly, various aspects of the communication platform were described above. The following will describe various use cases of the communication platform.

In accordance with aspects of the present disclosure, the communication platform can be used by large organizations to find in-house talent for open positions. For large organizations, it can be difficult to find in-house talent for open positions. While such organizations may encourage their employees to consider career moves within the organization, there may be politics involved because managers of those employees may not want employees to leave their team, and receiving managers may not want bad relations with the managers whose employees leave them.

Using the communication platform described herein, an organization may add all of its employees to the communication platform. Managers may use the communication platform to search just within their organization for in-house talent that may fit an open position. As mentioned above, the process of searching for other users is based on information other than user identity (which the searcher will not see), so employees have less risk of being directly identified as looking for a new position. This will enable easy and transparent job matching and reduce the risk of employees leaving to other companies.

In accordance with aspects of the present disclosure, the communication platform can be used for reporting harassment when the victim and the harasser are not in the same organization but they have occasion to be in contact with each other. For example, a sales representative from one organization may meet with a team of personnel from another organization. If a victim and a harasser are not in the same organization, the victim may not know the identity of the harasser and may not know whom to contact at the harasser's company to report the harassment. Furthermore, the victim may fear retaliation but may not have an anonymous method of filing a harassment report. For example, the sales representative may fear losing a client account if the sales representative files a harassment report. The typical anonymous hotlines/services are intended only for an organization's own employees.

A victim may use the communication platform described herein to find the right person to contact in the harasser's organization by searching for a person who works in human resources in the harasser's organization and at the harasser's work location. In various embodiments, the communication platform allows human resources representatives to add a tag which indicates they should be contacted in case of workplace harassment. Thus, the victim can find the right person and send them a message reporting the harassment, while remaining anonymous. The message sender can choose a message context of reporting harassment, and based on such context, the message sender can choose to stay anonymized even after there is a connection with the message recipient. Without sharing the message sender's information, the users can correspond via the communication platform so that even the message sender's personal or work email are not exposed.

In accordance with aspects of the present disclosure, a job recruiter may use the communication platform described herein to search for other users to identify candidates for an open job position. Because the job recruiter would not see the identity of the other users, the job recruiter would need to base their evaluation of the search results on other information, thereby reducing the chance of undue bias in evaluating the search results.

In accordance with aspects of the present disclosure, a job seeker may use the communication platform described herein to search for other users who may be hiring managers of companies the job seeker is interested in applying to. The job seeker may, for example, determine which hiring managers to message based on the warmth level of the hiring managers. For example, a job seeker may choose to send messages only to hiring managers who have a “Hot” warmth level, thereby having better assurance of receiving a reply.

In accordance with aspects of the present disclosure, a sales representative may use the communication platform described herein to search for other users who may be potential customers. The sales representative may, for example, determine which other users to message based on the warmth level of the other users. For example, a sales representative may choose to send messages only to other users who have a “Hot” warmth level, thereby having better assurance of receiving a reply.

Such use cases are merely examples, and other uses of the communication platform are contemplated to be within the scope of the present disclosure.

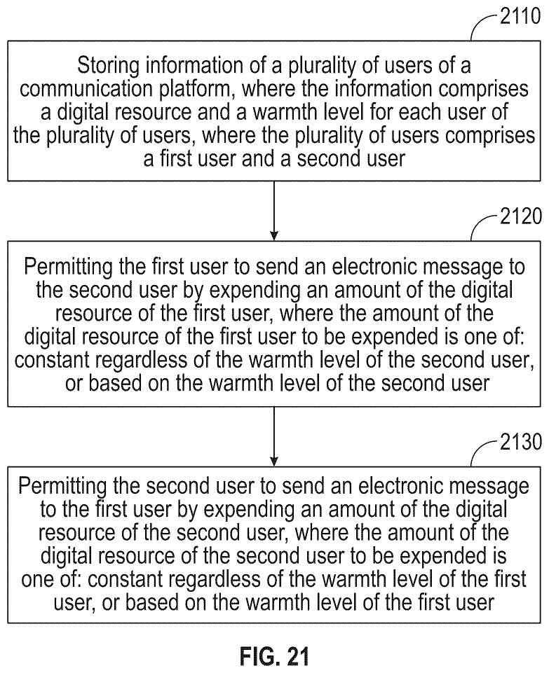

Referring now to FIG. 21, there is shown a flow diagram of an example of an operation, in accordance with aspects of the present disclosure.

At block 2110, the operation involves storing information of a plurality of users of a communication platform, where the information includes a digital resource and a warmth level for each user of the plurality of users, and where the plurality of users includes a first user and a second user. The warmth level may be the warmth level described in connection with FIG. 8.

At block 2120, the operation involves permitting the first user to send an electronic message to the second user by expending an amount of the digital resource of the first user, where the amount of the digital resource of the first user to be expended is based on the warmth level of the second user. The amount of digital resource to be expended may be the amounts shown in FIG. 8, for example.

At block 2130, the operation involves permitting the second user to send an electronic message to the first user by expending an amount of the digital resource of the second user, where the amount of the digital resource of the second user to be expended is based on the warmth level of the first user. The amount of digital resource to be expended may be the amounts shown in FIG. 8, for example.

FIG. 21 is merely an example, and variations are contemplated to be within the scope of the present disclosure. For example, any of the operations described in connection with FIGS. 1-20 may be performed in the operation of FIG. 21, and some of the blocks shown in FIG. 21 may or may not be performed. Such and other variations are contemplated to be within the scope of the present disclosure.

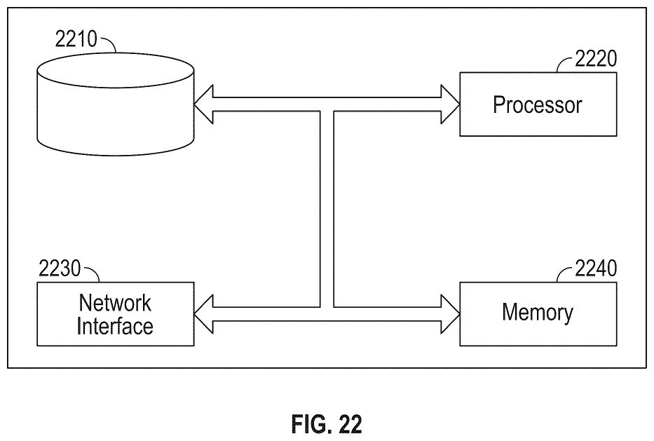

FIG. 22 is a block diagram of an example of components of a user device (e.g., 110, FIG. 1) or of a communication platform system (e.g., 120, FIG. 1.). The components may be used to perform any of the operations or any aspects of the operations described herein, including the aspects and operations described in connection with any of FIGS. 1-21.

The computing components include an electronic storage 2210, a processor 2220, a memory 2240, and a network interface 2230. The various components may be communicatively coupled with each other. The processor 2220 may be and may include any type of processor, such as a single-core central processing unit (CPU), a multi-core CPU, a microprocessor, a digital signal processor (DSP), a System-on-Chip (SoC), or any other type of processor. The memory 2240 may be a volatile type of memory, e.g., RAM, or a non-volatile type of memory, e.g., NAND flash memory. The memory 2240 includes processor-readable instructions that are executable by the processor 2220 to cause the system to perform various operations, including those mentioned herein, such as the operations described in connection with of FIGS. 1-21.

The electronic storage 2210 may be and include any type of electronic storage used for storing data, such as hard disk drive, solid state drive, and/or optical disc, among other types of electronic storage. The electronic storage 2210 stores processor-readable instructions for causing the system to perform its operations and stores data associated with such operations, such as storing data relating to any of the information described herein in connection with FIGS. 1-21. The electronic storage 2210 may be a non-transitory processor readable medium. The network interface 2230 may implement networking technologies, such as Ethernet, Wi-Fi, and/or other wireless networking technologies.

The components shown in FIG. 22 are merely examples, and persons skilled in the art will understand that a system includes other components not illustrated and may include multiples of any of the illustrated components. Such and other embodiments are contemplated to be within the scope of the present disclosure.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems, devices, and/or servers described herein may utilize one or more processors to receive various information and transform the received information to generate an output. The processors may include any type of computing device, computational circuit, or any type of controller or processing circuit capable of executing a series of instructions that are stored in a memory. The processor may include multiple processors and/or multicore central processing units (CPUs) and/or may include any type of device, such as a microprocessor, graphics processing unit (GPU), digital signal processor (DSP), neural processing unit (NPU), microcontroller, programmable logic device (PLD), field programmable gate array (FPGA), or the like. The processor may also include a memory to store data and/or instructions that, when executed by the one or more processors, causes the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. A processor-implemented method comprising:
storing information of a plurality of users of a communication platform, the information comprising a digital resource and a warmth level for each user of the plurality of users, wherein the plurality of users comprises a first user and a second user;
permitting the first user to send an electronic message to the second user by expending an amount of the digital resource of the first user, wherein the amount of the digital resource of the first user to be expended is one of: constant regardless of the warmth level of the second user, or based on the warmth level of the second user; and
permitting the second user to send an electronic message to the first user by expending an amount of the digital resource of the second user, wherein the amount of the digital resource of the second user to be expended is one of: constant regardless of the warmth level of the first user, or based on the warmth level of the first user.

2. The processor-implemented method of claim 1, further comprising, for each user of the plurality of users:
determining, for messages received by the respective user, a percentage of the messages to which the respective user has replied; and
determining the warmth level of the respective user based on the percentage.

3. The processor-implemented method of claim 1, further comprising determining an amount of new digital resource to be added to the digital resource of the first user,
wherein the amount of the new digital resource to be added is based on the warmth level of the first user.

4. The processor-implemented method of claim 1, further comprising:
determining that a number of messages that the first user is willing to receive, in a first period of time, from other users has been reached;
based on the determination, holding further messages sent to the first user during the first period of time; and
during a second period of time after the first period of time, delivering at least one of the further messages to the first user.

5. The processor-implemented method of claim 1, wherein the information of the plurality of users of the communication platform comprises, for the first user, at least one work experience and at least one education of the first user,
the processor-implemented method further comprising:
receiving a document containing text reflecting work experience and education of the first user,
inputting the text to a trained machine learning model, and
outputting, by the trained machine learning model, based on the text, the at least one work experience and the at least one education of the first user.

6. The processor-implemented method of claim 1, wherein the information of the plurality of users of the communication platform comprises, for the first user, at least one job skill of the first user and at least one years-of-experience corresponding to the at least one job skill,
the processor-implemented method further comprising:
receiving a document containing text reflecting work experience of the first user,
inputting the text to a trained machine learning model, and
outputting, by the trained machine learning model, based on the text, the at least one job skill of the first user, the at least one years-of-experience corresponding to the at least one job skill, and a start date and an end date of the at least one job skill.

7. The processor-implemented method of claim 6, wherein the trained machine learning model is a large language model (LLM),
the method further comprising inputting to the LLM a prompt detailing a way in which the text is to be parsed and detailing fields in which the text are to be stored,
wherein the LLM provides a structured output.

8. The processor-implemented method of claim 1, further comprising:
receiving a search request from the first user to search for other users of the plurality of users;
conducting a search based on the search request to identify matched users of the plurality of users; and
providing, to the first user, search results comprising certain information of the matched users.

9. The processor-implemented method of claim 8, wherein the search request comprises search parameters,
wherein the search parameters comprise at least one of:
average number of years at a company,
time since changed companies,
time since changed positions within a company,
number of years in a job skill,
an indication to not search past work experience and to search only current work experience, or
an indication to search past work experience differently from searching current work experience.

10. The processor-implemented method of claim 8, wherein in the search results, the certain information of the matched users does not include identity of the matched users.

11. The processor-implemented method of claim 10, further comprising, based on the first user connecting with at least one matched user of the matched users, providing the first user with access to identity of the at least one matched user.

12. The processor-implemented method of claim 8, wherein the conducting the search comprises determining a distance value between the first user and another user of the plurality of users.

13. The processor-implemented method of claim 12, the determining the distance value between the first user and the another user comprises:
for each information element of a plurality of information elements of the first user and of the another user, computing a distance value for the respective information element; and
computing the distance value between the first user and another user as a weighted sum of the distance values of the respective information elements.

14. The processor-implemented method of claim 12, wherein the determining the distance value between the first user and another user comprises executing a trained machine learning model.

15. The processor-implemented method of claim 14, further comprising:
generating training data for training a machine learning model to determine distance values between a pair of users, the training data comprising ground truth distance values,
wherein the ground truth distance values are generated based on at least one of:
behavior of users choosing to look into search results and to send messages to connect with the search results,
behavior of users choosing to look into search results but not to send messages to connect with the search results, or
behavior of users choosing to not look into search results.

16. The processor-implemented method of claim 8, further comprising:
gathering review activity over time comprising at least one of:
amount of time that a search result among the search results was displayed on a display screen,
whether the search result among the search results was ever displayed on a display screen, or
cursor activity relating to the search result among the search results.

17. The processor-implemented method of claim 16, further comprising determining, based on the review activity, at least one of:
whether the search result should not be included as a matched user of a subsequent search, or
whether the search result should be positioned farther down in a subsequent search.

18. The processor-implemented method of claim 1, further comprising, at least one of:
determining a negative persona reflective of certain information that has a meaningful detriment to the first user, wherein the negative persona corresponds to one of:
messages from the first user that were not opened by a recipient,
messages from the first user that were not answered by the recipient,
messages from the first user that did not result in a connection with the recipient, or
messages from the first user that resulted in a connection with the recipient but did not result in further benefits to the first user after the connection, or
determining a positive persona reflective of certain information that has a meaningful benefit to the first user, wherein the positive persona corresponds to one of:
messages from the first user that were opened by a recipient,
messages from the first user that were answered by the recipient,
messages from the first user that resulted in a connection with the recipient, or
messages from the first user that resulted in a connection with the recipient and resulted in further benefits to the first user after the connection.

19. The processor-implemented method of claim 1, wherein one of the first user or the second user is a job seeker, and wherein another one of the first user or the second user is a job hirer,
the method further comprising automatically matching the first user and the second user based on job parameters of the first user and job parameters of the second user,
wherein the automatically matching is performed without the first user or the second user performing a manual search.

20. The processor-implemented method of claim 1, further comprising:
determining without human intervention, based on job titles of the plurality of users, when each of the plurality of users was a manager or an individual contributor; and
providing analytics based on at least one of:
when users were a manager or an individual contributor,
number of cumulative years as a manager across all experiences,
number of cumulative years as an individual contributor across all experiences,
number of continuous years as a manager in latest experiences,
number of continuous years as an individual contributor in latest experiences,
number of cumulative years in a skill across all experiences,
number of continuous years in a skill in latest experiences,
number of years as a manager in latest X years of experiences,
number of years as an individual contributor in latest X years of experiences,
number of years in a skill in latest X years of experiences,
percentage of time as a manager across all years of experiences,
percentage of time as an individual contributor across all years of experiences,
percentage of time as a manager in latest X years of experiences,
percentage of time as an individual contributor in latest X years of experiences,
percentage of time in a skill across all years of experiences, or
percentage of time in a skill in latest X years of experiences,
wherein X>0 and X is configurable.

21. The processor-implemented method of claim 20, further comprising filtering the plurality of users based on at least one of:
whether users are currently a manager or an individual contributor,
number of cumulative years as a manager across all experiences,
number of cumulative years as an individual contributor across all experiences,
number of continuous years as a manager in latest experiences,
number of continuous years as an individual contributor in latest experiences,
number of cumulative years in a skill across all experiences,
number of continuous years in a skill in latest experiences,
number of years as a manager in latest X years of experiences,
number of years as an individual contributor in latest X years of experiences,
number of years in a skill in latest X years of experiences,
percentage of time as a manager across all years of experiences,
percentage of time as an individual contributor across all years of experiences,
percentage of time as a manager in latest X years of experiences,
percentage of time as an individual contributor in latest X years of experiences,
percentage of time in a skill across all years of experiences, or
percentage of time in a skill in latest X years of experiences,
wherein X>0 and X is configurable.
